(19) United States
(12) Patent Application Publication
(10) Pub. No.: US 2010/0118069 A1
(43) Pub. Date: May 13, 2010

(54) PRINTER AND PRINTING METHOD

(75) Inventors: Naoki Kayahara, Suwa-shi (JP); Shuichi Koganehira, Suwa-shi (JP); Kentaro Miyazaki, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/616,935

(22) Filed: Nov. 12, 2009

(30) Foreign Application Priority Data
Nov. 12, 2008 (JP) 2008-290168

(51) Int. Cl. B41J 29/38; B41J 2/015

(52) U.S. Cl. 347/9; 347/21

(57) ABSTRACT

A printer has a head ejecting an ink including a colorant, water, an alcoholic solvent, and a surfactant to form an image, and a control portion controlling the head so as not to eject the ink to edge pixels when the image is formed on a medium. In the above printer, the alcoholic solvent contains at least one slightly water-soluble alkanediol.

### BACKGROUND

1. Technical Field

The present invention relates to a printer and a printing method.

2. Related Art

An ink jet printer has been known which ejects a plurality of color inks to a medium to form an image thereon. In the ink jet printer described above, a phenomenon unfavorably occurs in which when a total ink weight per unit area (ejection duty) ejected to a medium is increased, an ink which is used heretofore is liable to agglomerate, and hence the above ink cannot be used at a high ejection duty. By the reason described above, since the ink is controlled not to be ejected at a high ejection duty, an ink density at which the ink bleeds may not be frequently obtained.

In Japanese Unexamined Patent Application Publication No. 10-100453, as one method for suppressing bleeding between colors, a technique for performing a pixel etching has been disclosed.

In order to perform brilliant color printing, it is necessary to increase the ink weight per unit area ejected to a medium. However, when the ink weight per unit area is increased, bleeding of ink and agglomeration thereof may occur, and there has been a problem in that pretty printing cannot be easily performed. That is, there has been a problem in that while the ink weight per unit area is increased in order to perform brilliant color printing, printing without having agglomeration and bleeding cannot be easily performed.

### SUMMARY

An advantage of some aspects of the invention is that printing is performed which suppresses agglomeration of ink and bleeding thereof while an ink weight per unit area ejected to a medium is increased.

A primary invention that obtains the above advantage is a printer comprising: a head ejecting an ink including a colorant, water, an alcoholic solvent, and a surfactant to form an image, the alcoholic solvent containing at least one slightly water-soluble alkanediol; and a control portion controlling the head so as not to eject the ink to edge pixels of the image when the image is formed on a medium.

Other features of the invention will be clearly understood from the specification and accompanying drawings.

### BRIEF DESCRIPTION OF THE DRAWINGS

The invention will be described with reference to the accompanying drawings, wherein like numbers reference like elements.

FIG. 1 is a block diagram showing an entire structure of a printing system.

FIG. 2A is a cross-sectional view of a printer.

FIG. 2B is a view illustrating a transport treatment for a sheet S provided in the printer.

FIG. 3 is a view illustrating detailed placement of four heads of a head unit.

FIG. 4 is a view illustrating agglomeration.

FIG. 5 is a view showing ink droplets on a medium when no bleeding occurs.

FIG. 6 is a view showing ink droplets on a medium when bleeding occurs.

FIG. 7 is a flowchart illustrating a printing data generation processing.

FIG. 8 is a flowchart illustrating a pixel etching processing.

FIG. 9 is a view illustrating pixels of an original image P.

FIG. 10 is a view illustrating pixels of a first post-resolution conversion image P′.

FIG. 11 is a view illustrating pixels of a second post-resolution conversion image P.

FIG. 12 is an edge filter used in an embodiment.

FIG. 13 is a view illustrating synthesis of post-filter application images F of individual planes.

FIG. 14 is a view illustrating pixels of a post-binary processing image E.

FIG. 15 is a view illustrating pixels of a post-binary processing image E′.

FIG. 16 is a view illustrating pixels of a post-pixel etching image C.

FIG. 17 is a view illustrating pixels of an image before pixel etching is performed.

FIG. 18 is a view illustrating pixels of a post-pixel etching image.

FIG. 19 is a view showing the solubility of 1,2-octanediol when individual alcoholic solvents are each added to an aqueous solution of 1,2-octanediol.

### DESCRIPTION OF EXEMPLARY EMBODIMENTS

From the specification and accompanying drawings, at least the following become apparent.

According to one embodiment of the invention, there is provided a printer comprising: a head ejecting an ink including a colorant, water, an alcoholic solvent, and a surfactant to form an image, the alcoholic solvent containing at least one slightly water-soluble alkanediol; and a control portion controlling the head so as not to eject the ink to edge pixels of the image when the image is formed on a medium.

By the structure as described above, while the ink weight per unit area ejected to the medium is increased, printing which suppresses agglomeration of ink and bleeding thereof can be performed.

In the printer described above, the alcoholic solvent preferably contains the slightly water-soluble alkanediol, a water-soluble 1,2-alkanediol, an alkanediol in which one carbon having a hydroxyl group has a side chain, and a water-soluble alkanetriol. In addition, the slightly water-soluble alkanediol is preferably an alkanediol having at least 7 carbon atoms. Furthermore, the water-soluble 1,2-alkanediol is preferably an alkanediol having 6 carbon atoms or less. In addition, the colorant preferably contains a pigment and a dispersant capable of dispersing the pigment in the ink.

In addition, it is preferable that when the image is formed on the medium, the control portion finds a post-filter application image which is obtained by applying an edge filter to the image, finds edge pixels by performing a binary processing on the post-filter application image, and uses a data in which pixels of the image corresponding to the edge pixels are set to colorless pixels, so that the head is controlled not to eject the ink to the edge pixels. In addition, the medium is preferably synthetic paper primarily containing a synthetic resin or coated printing paper.

By the structure described above, while the ink weight per unit area ejected to the medium is increased, printing which suppresses agglomeration of ink and bleeding thereof can be performed.

According to one embodiment of the invention, there is provided a printing method comprising: finding edge pixels of an image; and ejecting an ink including a colorant, water, an alcoholic solvent, and a surfactant to pixels other than the edge pixels to form the image on a medium, the alcoholic solvent containing at least one slightly water-soluble alkanediol.

By the method described above, while the ink weight per unit area ejected to the medium is increased, printing which suppresses agglomeration of ink and bleeding thereof can be performed.

### Embodiments

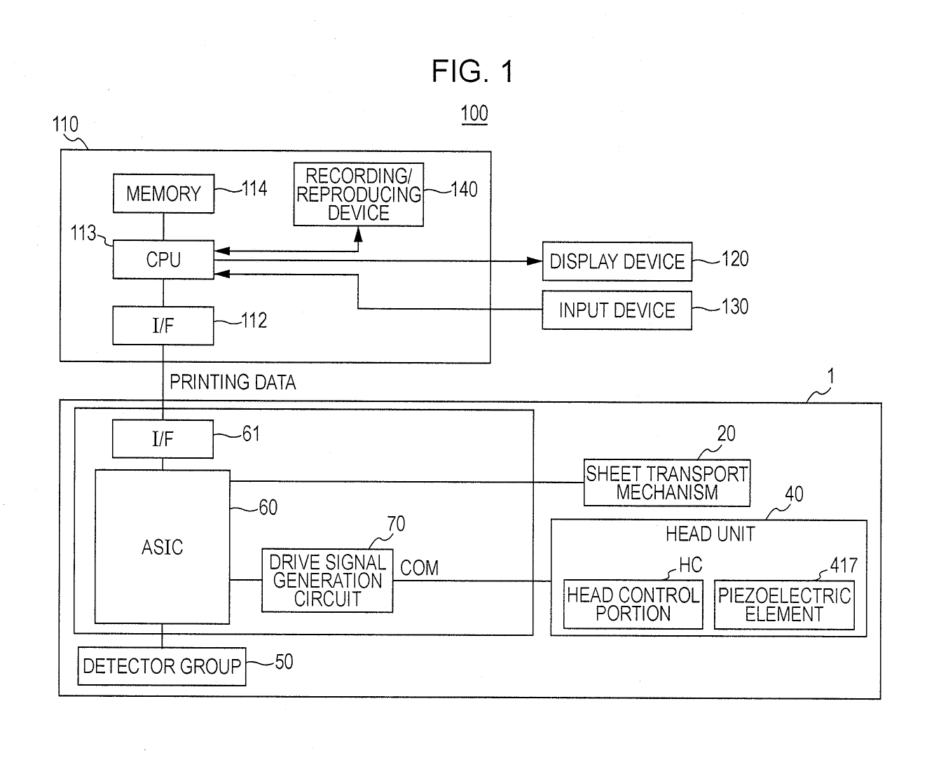

FIG. 1 is a block diagram of an entire structure of a printing system 100. This printing system 100 includes a printer 1, a computer 110, a display device 120, and an input device 130. In a first embodiment, the printer 1 is an ink ejection type line printer printing an image on a medium such as paper, cloth, or a film.

The computer 110 has a CPU 113, a memory 114, an interface 112, and a recording/reproducing device 140. The CPU 113 performs various programs, such as a printer driver, and for example, an image processing is performed on an image to be printed by the printer 1 which will be described later. The memory 114 stores programs and data, such as the printer driver. The interface 112 is an interface, such as a USB or a parallel interface, used for connection to the printer 1. The recording/reproducing device 140 is a device, such as a CD-ROM drive or a hard disc drive, for storing programs and data.

The computer 110 is communicably connected to the printer 1 through the interface 112, and in order to enable the printer 1 to print an image, a printing data in accordance with an image to be printed is output to the printer 1.

In the computer 110, the printer driver is installed. The printer driver is a program which enables the display device 120 to display a user interface and which converts an image data output from an application program to the printing data.

### Structure of Printer

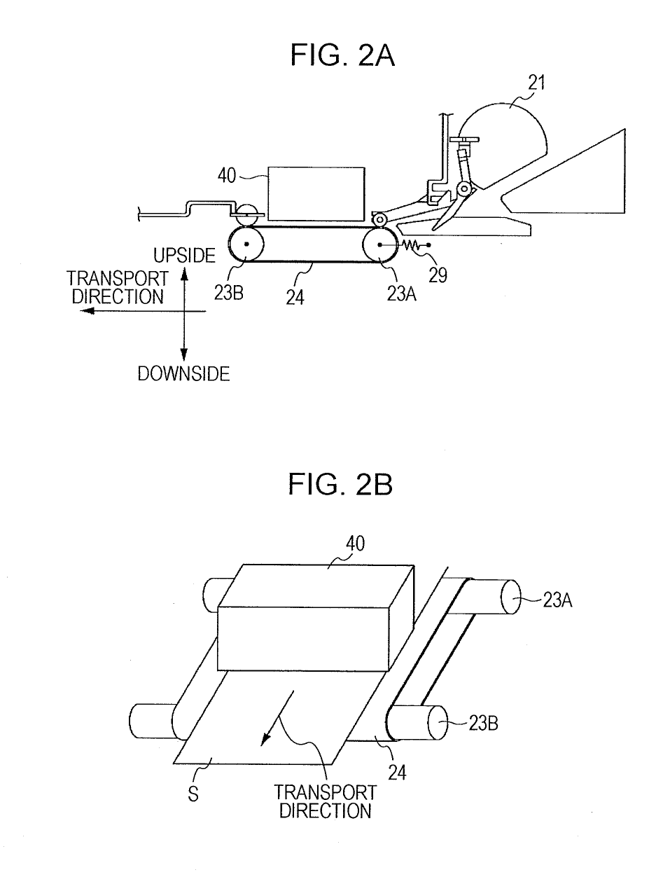

FIG. 2A is a cross-sectional view of the printer 1. In addition, FIG. 2B is a perspective view illustrating a transport treatment for a sheet S provided in the printer 1. Hereinafter, with reference to FIGS. 2A and 2B together with FIG. 1, a basic structure of a line printer will be described.

The printer 1 has a sheet transport mechanism 20, a head unit 40, a detector group 50, an ASIC 60, and a drive signal generation circuit 70. The printer 1 receives the printing data from the computer 110. In addition, based on the data thus received, the ASIC 60 of the printer 1 controls individual portions (the sheet transport mechanism 20, the head unit 40, and the drive signal generation circuit 70) of the printer 1 and prints the image on the sheet S.

The status inside the printer 1 is monitored by the detector group 50. The detector group 50 outputs detection results to the ASIC 60. Subsequently, based on the detection results, the ASIC 60 controls the individual portions.

The sheet transport mechanism 20 functions to transport a medium (such as the sheet S) in a predetermined direction (hereinafter referred to as a “transport direction”). This sheet transport mechanism 20 has a sheet supply roller 21, a transport motor (not shown), an upstream-side transport roller 23A, a downstream-side transport roller 23B, and a belt 24. The sheet supply roller 21 is a roller to supply the sheet S inserted in a sheet inlet into the printer 1. The downstream-side transport roller 23B is connected to the transport motor not shown in the figure. When the transport motor is driven, the downstream-side transport roller 23B is rotated. Accordingly, the belt 24 is rotated together with the downstream-side transport roller 23B, and the upstream-side transport roller 23A is also rotated. The rotation of the transport motor not shown in the figure is controlled by the ASIC 60. The upstream-side transport roller 23A is provided with a spring 29. In addition, the upstream-side transport roller 23A is configured to slightly move in a horizontal direction so as to prevent the flexure of the belt 24.

The sheet S supplied by the sheet supply roller 21 is transported to a printable region (a region facing the head) by the belt 24. Since the belt 24 transports the sheet S, the sheet S is moved to the head unit 40 in the transport direction. The sheet S passing through the printable region is discharged outside by the belt 24. In addition, the sheet S during the transport is static or vacuum chucked to the belt 24.

The head unit 40 is a unit to eject ink droplets to the sheet S. The head unit 40 ejects ink droplets to the sheet S in the transport to form dots thereon, so that an image is printed on the sheet S. This printer 1 is a line printer, and as will be described later, the head unit 40 has four heads, that is, a first head 410 to a fourth head 440. The structure of this head unit 40 will be described later in detail.

The detector group 50 includes a rotary encoder (not shown) and the like. The rotary encoder detects the rotation amount of the upstream-side roller 23A and that of the downstream-side roller 23B. Based on the detection results of the rotary encoder, the ASIC 60 can detect the transport amount of the sheet S. Accordingly, it is configured that a predetermined transport amount of the sheet S can be controlled.

The ASIC 60 is a control unit to control the printer 1. The ASIC 60 is connected to an interface portion 61 provided inside the printer 1 so as to be communicable with the computer 110. The ASIC 60 has a function to perform a computation processing for controlling the entire printer. In addition, a memory storing programs and data is also included. Furthermore, according to the program stored in the memory, the individual mechanisms are controlled.

In order to eject ink droplets from a nozzle, the drive signal generation circuit 70 is a circuit generating a drive signal to be applied to a piezoelectric element 417 provided in the head. The drive signal generation circuit 70 outputs a drive signal to the head unit 40 based on a waveform data output from the ASIC 60. The drive signal is a signal including a plurality of drive pulses in a predetermined cycle T. The drive pulse is a pulse selectively applied to the piezoelectric element 417 so as to eject an ink droplet. The drive signal is repeatedly generated from the drive signal generation circuit 70 and is output.

### Structure of Head Unit

Again with reference to FIG. 1, the individual heads of the head unit 40 each include a head control portion HC. In addition, by the control of the head control portion HC, a drive pulse applied to the piezoelectric element 417 of each nozzle is selected. Subsequently, when the drive pulse is applied to the piezoelectric element 417, each nozzle is configured to eject an ink droplet. The head control portion HC is controlled by the ASIC 60. Accordingly, by the ASIC 60, ejection timing of each nozzle can be changed.

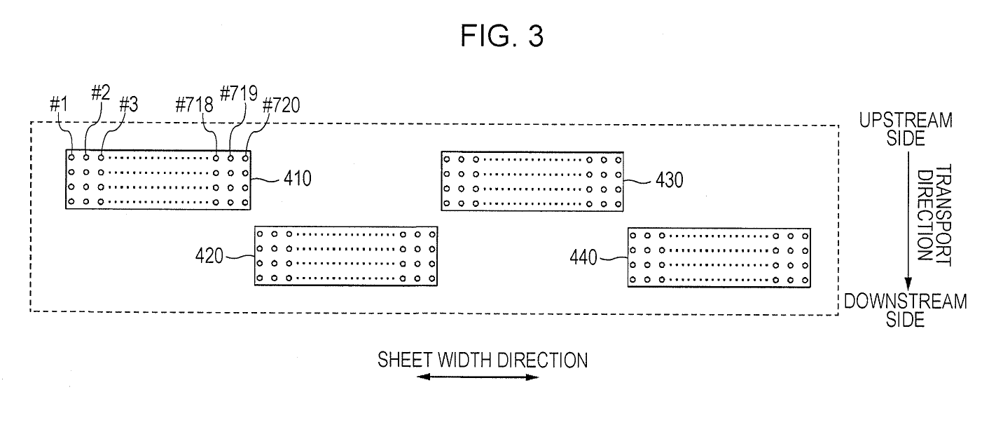

FIG. 3 is a view illustrating detailed placement of the four heads of the head unit 40. In the figure, the first head 410 to the fourth head 440 are viewed from an upper portion of the printer 1. When the heads are viewed from the upper portion of the printer 1, the nozzles of the heads are not viewed since being covered with other elements. However, in this figure, in order to facilitate understanding of the relationship of the nozzles of the first head 410 to the fourth head 440, the positions of the nozzles are each shown by a solid line.

In the head unit 40, the four heads, that is, the first head 410 to the fourth head 440, are included. These heads are disposed so that the direction perpendicular to a nozzle line direction coincides with the transport direction of a sheet. In addition, in each head, four nozzle lines are included so as to eject ink droplets having four different colors. The distance (nozzle pitch P) between the nozzles in each nozzle line is set to 1/720 inch. In addition, for each color, 720 nozzles and the piezoelectric elements 417 ejecting ink droplets therefrom are included. The piezoelectric elements 417 are independently provided for the individual nozzles. In addition, in order to further improve a printing resolution, a head having a nozzle pitch smaller than that described above may also be used. In addition, a head unit similar to the head unit 40 may also be disposed at the down-stream side thereof at a position shifted in the nozzle line direction by P/2 so as to perform printing having a higher resolution.

In addition, the distance between a nozzle #720 of the first head 410 and a nozzle #1 of the second head 420 is set to the nozzle pitch P ( 1/720 inch). The second head 420 to the fourth head 440 are also each disposed so as to have the distance similar to that described above.

### Agglomeration

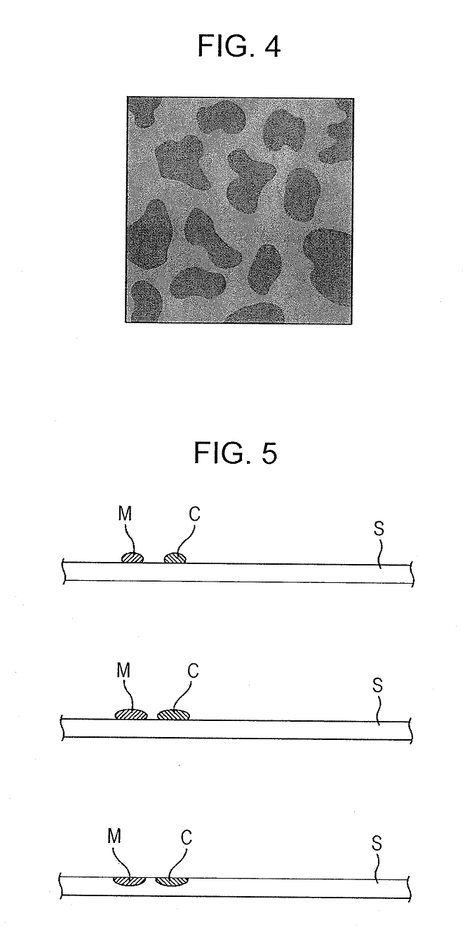

FIG. 4 is a view illustrating the agglomeration. The agglomeration indicates local density irregularities having similar colors which are generated when ink is ejected. Once the agglomeration occurs, due to the density irregularities described above, printing having a rough touch, that is, printing having a grainy touch, is performed. Hence, in order to perform high quality printing, it is necessary to reduce the agglomeration described above.

It is believed that since the surface tension of an ink dot is high, and the contact angle between the surface of coated printing paper and an ink droplet is high, the coated printing paper repels the ink, and hence the agglomeration thereof described above occurs. Accordingly, it is also believed that when the surface tension of an ink adhering to the surface of coated printing paper is reduced as described later, the agglomeration of the ink can be suppressed.

In addition, in particular, the agglomeration of ink described above tends to occur at a place at which an ejection amount of ink is large. In addition, since an ink which is used heretofore generates the agglomeration as described above, the ejection amount of the ink per unit area cannot be increased, and hence brilliant color printing cannot be disadvantageously performed. Accordingly, in this embodiment, by using the following ink composition, while the ink weight per unit area is increased, printing which suppresses the agglomeration is performed.

### Bleeding

Incidentally, when the total ink weight per unit area is increased to perform brilliant color printing by using the ink which is not likely to generate agglomeration as described above, bleeding in which different colors bleed into each other occurs.

FIG. 5 is a view showing ink droplets on a medium when no bleeding occurs. In the figure, a droplet of a magenta ink M and a droplet of a cyan ink C are shown. In this case, for the sake of convenience of illustration, the droplets of single ink colors are shown. As shown in the figure, when the dot size is small, of course, the two ink droplets cause no bleeding, and even when the dot size is large, the two ink droplets also cause no bleeding by mixing since being separated from each other. In this case, also in order to simplify description, the droplets of single ink colors are described by way of example; however, even when one ink droplet has a synthetic color formed from a plurality of ink colors, as in the case described above, no bleeding also occurs as long as the two ink droplets are separated from each other. In addition, as shown in the figure, even when the ink droplets infiltrate into the sheet S, the inks inside the sheet S are separated from each other, and hence they are not mixed with each other.

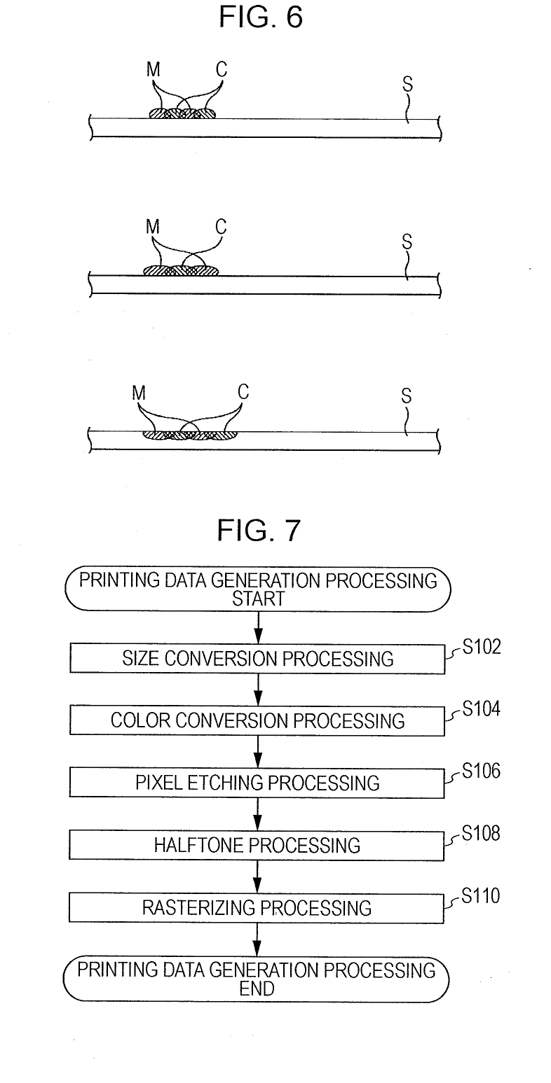

FIG. 6 is a view showing ink droplets on a medium when bleeding occurs. As shown in the figure, regardless whether the dot size is large or small, when the total ink weight per unit area is large, ink droplets landing on the sheet S are overlapped with each other on a sheet. That is, the two types of inks are mixed together on the sheet, so that bleeding occurs.

In addition, even when one type of ink droplet shown in the figure has a synthetic color formed from a plurality of ink colors, if different colors are mixed together on the sheet, bleeding occurs, and as a result, a color different from the original color is formed. When the synthetic color is generated by synthesis among desired colors, an image formed therefrom also has a desired color. However, when two types of inks which are not expected from the beginning are mixed together to cause bleeding, the quality of image is degraded.

By the way, it is believed that one type of bleeding which occurs in gradation in which color gradually changes may not cause any serious visual problems. However, on the other hand, when bleeding occurs between different colors at a position at which the colors rapidly change, an edge portion of an image becomes vague, and the degradation in quality of the image becomes apparent.

Accordingly, in the embodiment described below, edge pixels at which colors rapidly change are intentionally set to colorless pixels (hereinafter referred to as “pixel etching”). In addition, in subsequent ejection of ink, the ink is configured not to be ejected to places corresponding to the edge pixels. By the configuration described above, bleeding in which colors rapidly changing at the edge pixels are mixed together can be prevented, and as a result, a superior image can be obtained.

That is, in this embodiment, printing is performed using an ink shown below and by the following method in which bleeding is not likely to occur, so that printing which suppresses agglomeration of ink and bleeding thereof is performed while the ink weight per unit area ejected to a medium is increased.

### Printing Data Generation Processing

FIG. 7 is a flowchart illustrating a printing data generation processing. As shown in the figure, in the printing data generation processing, a size conversion processing (S102), a color conversion processing (S104), a pixel etching processing (S106), a halftone processing (S108), and a rasterizing processing (S110) are performed.

The processings from the size conversion processing (S102) to the rasterizing processing (S110) are performed by the printer driver of the computer 110. In addition, a printing data processed by the rasterizing processing is sent to the printer 1. However, these processings may also be performed in the ASIC 60 of the printer 1.

The size conversion processing (S102) is a processing in which an image data is converted into a data having a resolution at which an image is printed on the sheet S. In this embodiment, in order to discriminate the above processing from a resolution conversion processing performed in the pixel etching processing which will be described later, the above processing is called the size conversion processing.

The color conversion processing (S104) is a processing in which each RGB pixel data of a RGB image data is converted into a data having multistage gradation values represented by a YMCK color space. This color conversion processing is performed with reference to a table (color conversion lookup table) in which the RGB luminance value and the YMCK gradation value are corresponded to each other.

After the color conversion processing is completed, the pixel etching processing (S106) is then performed. The pixel etching processing will be described later in detail.

After the pixel etching processing is completed, the halftone processing (S108) is performed. The halftone processing is a processing in which a YMCK pixel data having multistage gradation values is converted into a data having a smaller number of gradation values which can be expressed by the printer. By this halftone processing, for example, from a YMCK pixel data having 256 gradation values, a 2-bit dot forming data showing four gradation values is obtained. That is, any one of the 2-bit dot forming data including [00] indicating no dot, [01] indicating a small dot, [10] indicating a medium dot, and [11] indicating a large dot is set for each pixel.

For the halftone processing of this embodiment, for example, a dither processing may be used. For the halftone processing of this embodiment, a method, such as an error diffusion method, is not used in which dots are generated at positions at which dots are not originally present. The reason for this is that although the edge pixels are set to colorless pixels by the pixel etching which will be described later, if dots are formed at positions corresponding to the edge pixels by using an error diffusion method, the pixel etching processing results in nothing.

Although the pixel etching processing is performed before the halftone processing (S108) in this embodiment, it may be performed thereafter.

The rasterizing processing (S110) is a processing in which the order of the dot forming data obtained by the halftone processing is changed in accordance with the order of the data to be transferred to the printer. The dot forming data processed by the rasterizing processing is sent as the printing data to the printer 1 together with a command data and the like. The printer 1 receives the printing data and sends the dot forming data processed by the rasterizing processing to the head control portion HC. The head control portion HC performs printing on the sheet S in accordance with the dot forming data of each pixel. By the processings described above, printing of a desired image is performed.

### Pixel Etching Processing

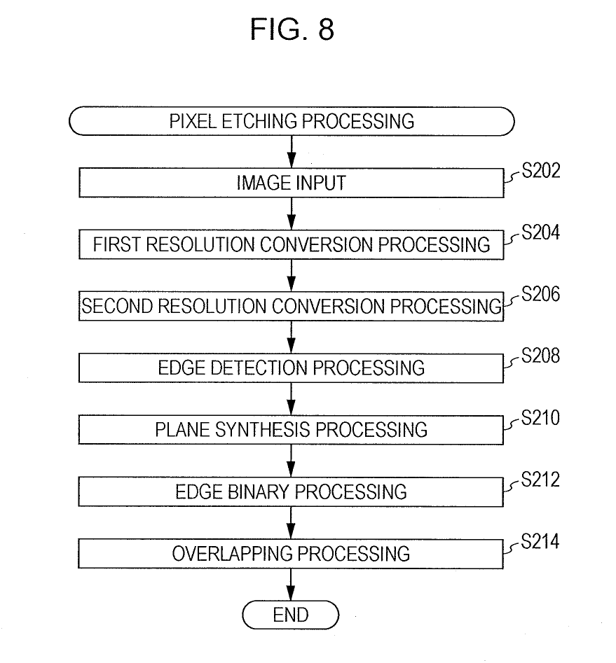

FIG. 8 is a flowchart illustrating the pixel etching processing. In this embodiment, a method for performing a pixel etching processing on one pixel line located along a color boundary will be described. In addition, as an image data, individual pixels have gradation values in the YMCK color space.

In this processing, the printer 1 is controlled to print an image processed by the pixel etching processing and is also controlled not to eject ink to the edge pixels. When the pixel etching processing is performed by the printer driver of the computer 110, the computer 110 and the ASIC 60 of the printer 1 correspond to the control portion of the printing system 100. However, when the pixel etching is performed by the ASIC 60 of the printer 1, this ASIC 60 corresponds to the control portion of the printing system 100.

First, an image to be processed by the pixel etching processing is input (S202). In this step, the image to be processed by the pixel etching processing is called “original image P” for convenience.

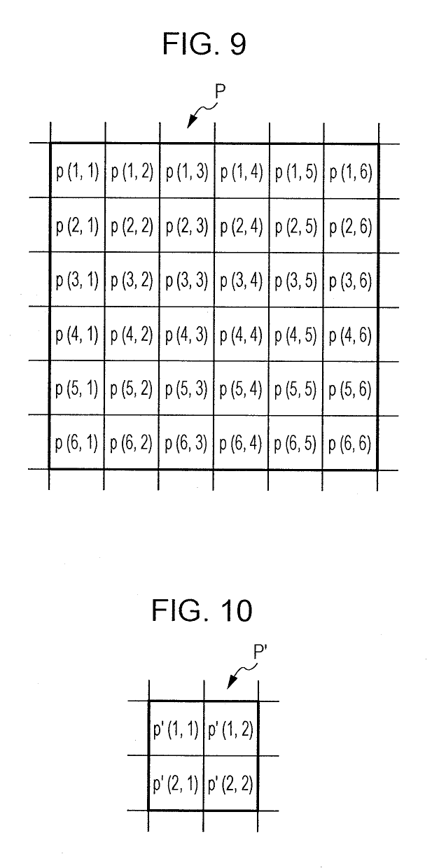

FIG. 9 is a view illustrating individual pixels of the original image P. In the figure, some pixels of the original image P are shown. In addition, gradation values p of the individual pixels are shown in the form of an array.

When the original image P is input, a first resolution conversion processing is performed (S204). In consideration of a subsequent processing in which the resolution of an image is increased to the integral multiple thereof, the first resolution conversion processing is a processing in which the size of the image is reduced beforehand by reducing the resolution thereof.

In this embodiment, by a bicubic method, the resolution of the original image P is reduced to one third thereof. For example, when the resolution of the original image P is 720 dpi, the resolution is reduced to 240 dpi. An image processed by the first resolution conversion processing is called a “post-first resolution conversion image P′” for convenience. The processing as described above is performed on each YMCK plane.

FIG. 10 is a view illustrating individual pixels of the post-first resolution conversion image P′. In the figure, some pixels of the post-first resolution conversion image P′ are shown. In addition, gradation values P′ of the individual pixels of the post-first resolution conversion image P′ are shown in the form of an array.

In this processing, the conversion is performed so that the resolution is reduced to one third. Hence, a plurality of pixels surrounded by heavy lines shown in FIG. 9 is converted so as to correspond to one pixel shown in FIG. 10. For example, pixels including p(1, 1) to p(3, 3) in a region surrounded by heavy lines are converted to correspond to a pixel p′(1, 1) in FIG. 10.

Next, a second resolution conversion processing is performed (S206). In the second resolution conversion processing, the resolution of the post-first resolution conversion image P′ is increased by a magnification equal to or larger than the number of matrix of an edge detection filter (edge filter) which will be used later. In this embodiment, since the number of matrix of the edge detection filter is 3, as the magnification of the resolution conversion in the second resolution conversion processing, a value of 3 or more (3, 4, 5, - - - ) may be used; however, in this case, the conversion of the image is performed so that the resolution of the post-first resolution conversion image P′ is increased by 6 times. In this embodiment, an image obtained after the resolution of the post-first resolution conversion image P′ is converted is called a “post-second resolution conversion image P″” for convenience.

As a result, the resolution of the post-second resolution conversion image P″ is increased to 1,440 dpi. That is, it is understood that the resolution of the post-second resolution conversion image P″ is 2 times the resolution of the original image P.

As a conversion method used in the second resolution conversion processing, a method, such as a nearest neighbor method which uses an actual value located at the nearest point as an interpolation value, is used. The reason the method described above is used is to avoid the generation of gradation, which is not present in the original image P, in the post-second resolution conversion image P″.

In addition, in the second resolution conversion processing, the reason the image is converted in accordance with the value corresponding to the size of matrix of the edge detection filter (for example, when a 3×3 edge detection filter is used, the value is an integer of 3 or more) is that, in order to at least obtain edge pixels when a 3×3 edge filter is used, at least 3 pixels having the same color must be continuously aligned.

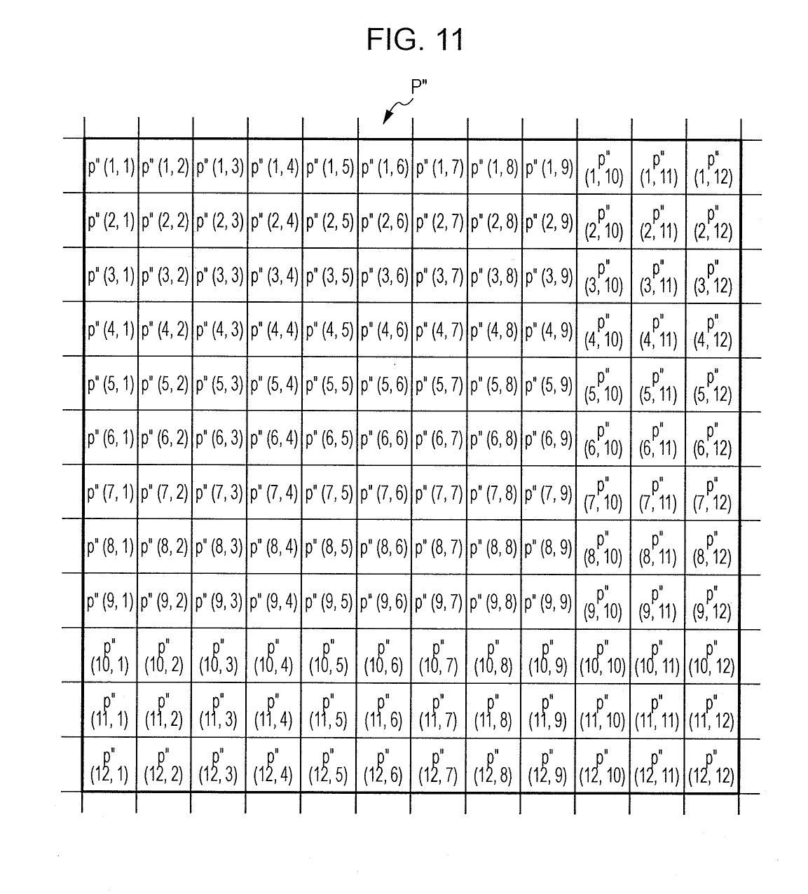

FIG. 11 is a view illustrating individual pixels of the post-second resolution conversion image P″. In the figure, some pixels of the post-second resolution conversion image P″ are shown. In addition, gradation values p″ of the individual pixels after the conversion are shown in the form of an array.

In this case, the conversion processing of the image is performed so that the resolution is increased by 6 times. Accordingly, one pixel surrounded by heavy lines in FIG. 10 is converted so as to correspond to 6×6 pixels surrounded by heavy lines in FIG. 11. For example, the pixel p′(1, 1) shown in FIG. 10 is converted to correspond to pixels p″(1, 1) to p″(6, 6) shown in FIG. 11. The processing described above is performed on each YMCK plane.

Next, an edge detection processing is performed (S208). In the edge detection processing, an edge detection filter is applied to the post-second resolution conversion image P″.

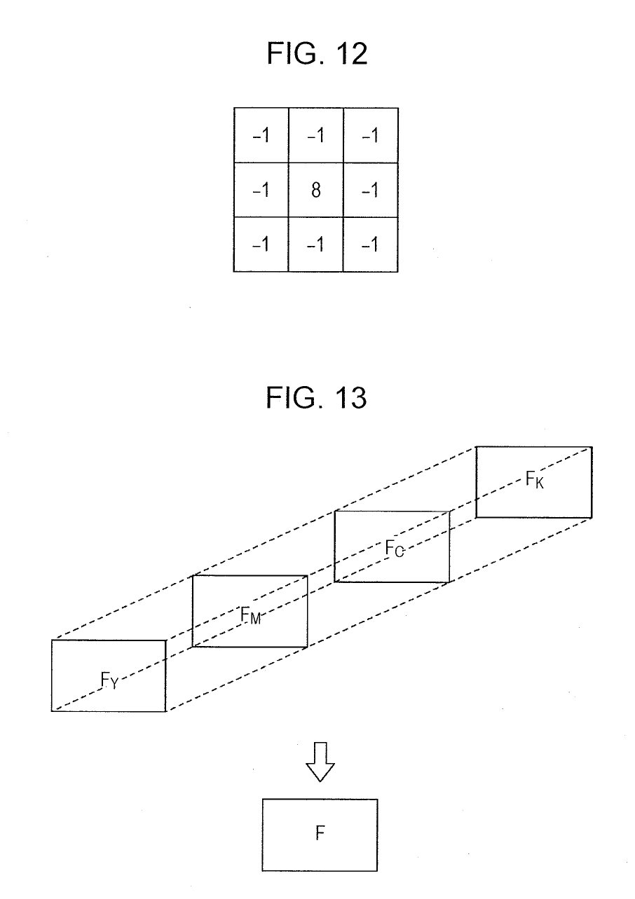

FIG. 12 is an edge detection filter used in this embodiment. In this embodiment, as shown in the figure, a 3×3 edge detection filter is used. When an edge filter is applied to an image, in a pixel having a strong edge, a high value is obtained. On the other hand, in a pixel having a not strong edge, a low value is obtained. That is, when the change in color is rapid, a high value is set, and when the change in color is not rapid, a low value is set. In addition, the edge detection filter used in this embodiment is not limited to that shown in FIG. 12.

The edge detection filter is applied to each plane of the YMCK. In addition, a post-filter application image F is obtained by applying the edge detection filter to each plane.

Next, a plane synthesis processing for synthesizing the post-filter application images of the individual planes is performed (S210).

FIG. 13 is a view illustrating the synthesis of the post-filter application images F of the individual planes. The synthesis of the post-filter application images of the individual planes is performed by obtaining the average of values set for pixels of the post-filter application images F of the individual planes which are located at the same position. That is, in order to perform the synthesis of the post-filter application images of the individual planes, the average of the values which are set for pixels located at the same array number of the post-filter application images of the individual planes is obtained. In the figure, the post-filter application images of the individual planes are shown (letters of YMCK are provided as a suffix for the post-filter application images F to indicate the respective planes). As described above, the post-filter application images of the four planes are converted to one post-synthesis post-filter application image F.

Next, an edge binary processing is performed (S212). In the edge binary processing, the values of the individual pixels of the post-synthesis post-filter application image are converted to one of the two values using a predetermined threshold as the standard. In this embodiment, the predetermined threshold is 128, and the two values are 0 and 255. In addition, in the post-synthesis post-filter application image, a pixel having a value equal to or more than the threshold value is set to have a value of 0. That is, a pixel having a strong edge is set to have a value of 0. On the other hand, a pixel having a value of less than 128 is set to have a value of 255. That is, a pixel having a weak edge is set to have a value of 255. An image obtained as described above is called a post-binary processing image E for convenience.

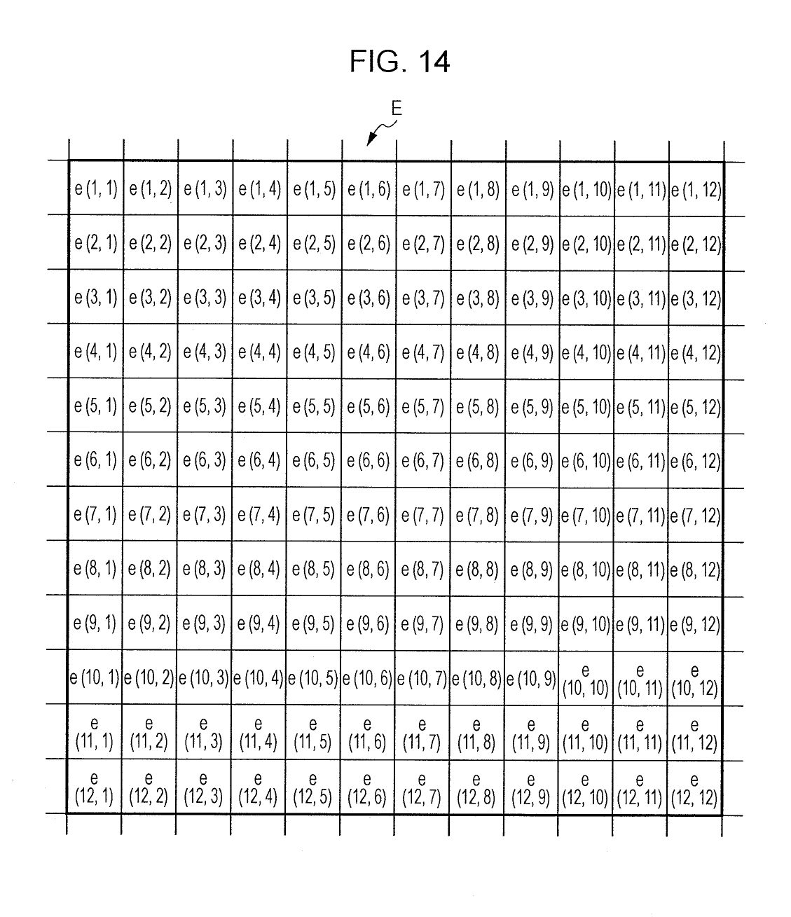

FIG. 14 is a view illustrating individual pixels of the post-binary processing image E. In the figure, some pixels of the post-binary processing image E are shown. In addition, values e of the individual pixels are shown in the form of an array.

At this stage, although the resolution of the post-binary processing image E is 1,440 dpi, in this step, a processing for reducing the resolution is again performed. In this embodiment, the resolution of the post-binary processing image E is reduced by one half thereof to 720 dpi by a nearest neighbor method. In addition, the post-binary processing image E processed by the resolution conversion is called a new post-binary processing image E′.

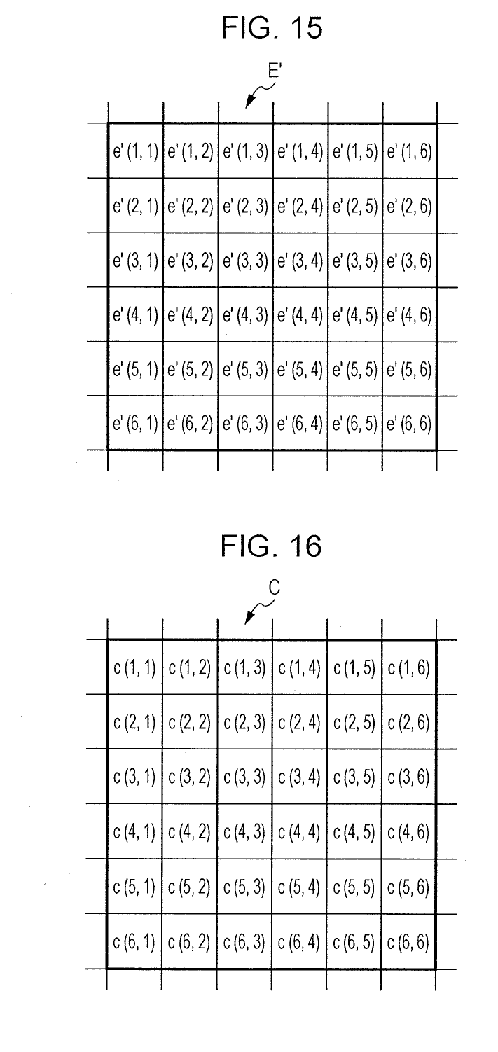

FIG. 15 is a view illustrating individual pixels of the post-binary processing image E′. In the figure, some pixels of the post-binary processing image E′ are shown. In addition, values e′ of the individual pixels are shown in the form of an array. As described above, in this processing, the conversion processing is performed so that the resolution is reduced to one half. Hence, 2×2 pixels surrounded by heavy lines shown in FIG. 14 is converted so as to correspond to one pixel shown in FIG. 15. For example, pixels e(1, 1) to e(2, 2) surrounded by heavy lines in FIG. 14 is converted to correspond to a pixel e′(1, 1) in FIG. 15.

Next, an overlapping processing is performed on the post-binary processing image E′ (S214). In the overlapping processing described above, the value of a pixel of the post-binary processing image E′ and the gradation value of a pixel of the original image P, which is located at the same position as that of the above pixel, are compared with each other, and a lower value is used as the gradation value of the pixel, so that a post-pixel etching image C is obtained.

FIG. 16 is a view illustrating individual pixels of the post-pixel etching image C. In the figure, some pixels of the post-pixel etching image C are shown. In addition, values c of the individual pixels are shown in the form of an array. When a function min is a function to select a lower value, the gradation value of each pixel c(x, y) of the post-pixel etching image C is represented as shown below by using a pixel p(x, y) of the original image P and a pixel e′ of the post-binary processing image E′.

C(x,y)=min(p(x,y),e′(x,y))

In addition, this processing is applied to each YMCK plane of the original image P.

A value of 0 or a value of 255 is set for each pixel of the post-binary processing image E′. In addition, a value of 0 is set for a pixel having a strong edge, and a value of 255 is set for a pixel having a weak edge. In addition, one of values from 0 to 255 is set as a gradation value for each pixel of the original image P. In this embodiment, since the YMCK color space is used, and a subtractive color mixture is used in the YMCK color space, a brighter color is obtained as the gradation value is closer to 0, and a darker color is obtained as the gradation value is closer to 255. When a lower value is selected according to the above equation, in a pixel of the post-binary processing image E′ in which the value is set to 0, 0 is set as the gradation value. On the other hand, in a pixel of the post-binary processing image E′ in which the value is set to 255, the gradation value of the original image P is set as the gradation value.

As described above, a pixel of the post-pixel etching image C which corresponds to a pixel of the original image P having a strong edge is set to have a gradation value which shows a white color. Subsequently, when printing is performed based on the data in which the gradation values are set for the individual pixels as described above, ink is not ejected to white pixels. That is, to a position at which the edge is strong and the change in color is rapid, the ink is configured not to be ejected. By the configuration described above, an image can be obtained which can prevent ink bleeding at the position described above.

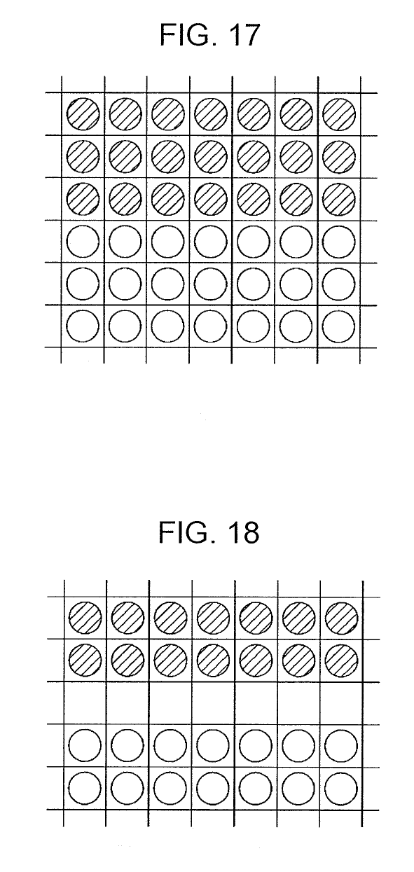

FIG. 17 is a view illustrating an image before the pixel etching is performed. In the figure, the state is shown in which two different colors are set for individual pixels. In this case, in order to simplify description, the number of different colors is set to only two. In addition, for the sake of convenience of description, a circle with oblique lines is used as a first color, and a white circle is used as a second color.

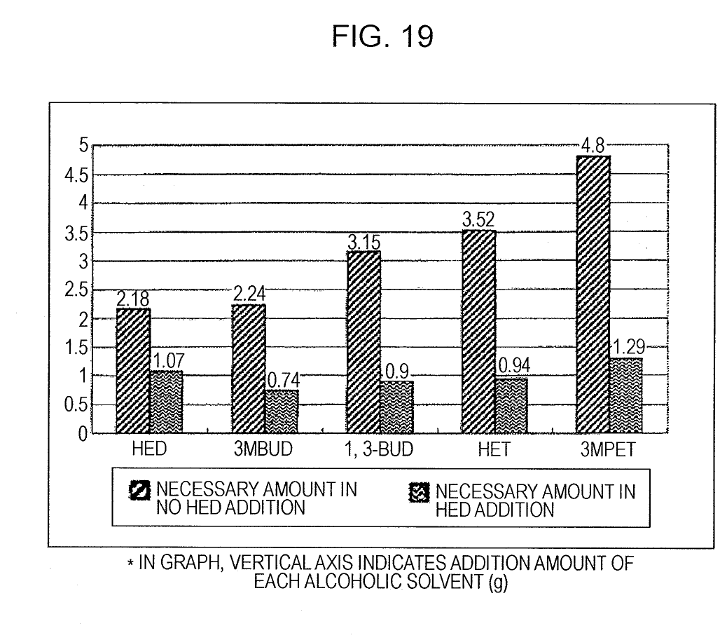

FIG. 18 is a view illustrating pixels of the post-pixel etching image. In the figure, in the post-pixel etching image, the state is shown in which the color of one of the first color pixel and the second color pixel adjacent to each other is set to colorless.

By performing the pixel etching described above, as shown in the figure, the color of the pixel at the boundary between the two different colors can be easily set to colorless. In addition, subsequently, a printing data for ejecting ink droplets is formed based on a data of pixels having the gradation values thus determined. Accordingly, when printing is performed based on this printing data, since being not ejected to the colorless pixels, ink droplets are not ejected to the boundary between the two different colors. Since the region in which ink droplets are not ejected to the boundary between the different colors is set as described above, bleeding between two different colors can be prevented.

In addition, when the reduction rate in the first resolution conversion processing is increased, the amount of missing information may increase in some cases. Hence, in the case in which the number of matrix of an edge filter is 3 as described above, it may be performed in such a way that the resolution is reduced to one half in the first resolution conversion processing (S204), the resolution is increased by 4 times in the second resolution conversion processing (S206), and the resolution is then reduced to one half in the edge binary processing. By the processings described above, the pixel etching processing can be performed while the amount of missing information of the original image can be decreased as small as possible.

The magnification of each resolution conversion in the case other than the above embodiment may be set using a general method as described below. For example, when the number of matrix of an edge filter is set to i, magnification j in the second resolution conversion processing (S206) can be set to i or more (for example, when i=3, j=3, 4, 5, - - - ). In accordance therewith, the magnification of the resolution conversion in the edge binary processing (S212) can be set to (1/(j−1)) times. In addition, in order to make the resolution of an image which is finally obtained equal to that of the original image P, the magnification of the resolution conversion in the first resolution conversion processing (S204) can be set to ((j−1)/j) times.

### Ink

An ink composition for ink jet recording according to this embodiment at least includes a colorant, water, an alcoholic solvent, and a surfactant, and the alcoholic solvent contains a slightly water-soluble alkanediol, a water-soluble 1,2-alkanediol, an alkanediol in which one carbon having a hydroxyl group has a side chain, and a water-soluble alkanetriol. Hereinafter, the components will be described.

### DEFINITION

In the specifications, the alkanediol and alkanetriol each may have a straight chain or a branched chain.

In addition, the “water-soluble” indicates a solubility in water of 10.0 g or more (which is the amount of a solute with respect to 100 g of water) at 20° C., and the “slightly water-soluble” indicates a solubility to water is less than 1.0 g (which is the amount of a solute with respect to 100 g of water) at 20° C.

### Alcoholic Solvent

The alcoholic solvent used in the ink composition for ink jet recording according to this embodiment contains at least four types of organic solvents, that is, a slightly water-soluble alkanediol, a water-soluble 1,2-alkanediol, an alkanediol in which one carbon having a hydroxyl group has a side chain, and a water-soluble alkanetriol. Since these four types of alcoholic solvents are contained as essential components, agglomeration of ink is suppressed on coated printing paper, in particular, on paper having a relatively high capability of absorbing ink such as art paper, paper for POD applications (for example, Ricoh business coat gloss 100 manufactured by Ricoh Company, Ltd.), and special paper for laser printers (for example, LPCCTA4 manufactured by SEIKO EPSON CORPORATION), and high-quality images without generating white streaks and/or rough touch can be provided even when printing is performed at a low resolution, so that an ink composition having superior ejection stability can be realized. In addition, in this specification, the “agglomeration” indicates local density irregularities having similar colors which are generated when a solid image is printed (for example, when a square having a side length of 6 inch is printed with a single color (this does not mean the number of ink colors)). The “agglomeration” does not indicate the state in which portions which are not covered with ink remain on the surface of a recording medium. In addition, the “white streaks” indicates, when a solid image is printed (for example, when a square having a side length of 6 inch is printed with a single color), a phenomenon in which no local density irregularities having similar colors are generated and portions in the form of streaks which are not covered with ink remain on the surface of a recording medium in a drive direction of a recording head. The “rough touch” or “filling failure” indicates, when a solid image is printed in a manner similar to that described above, a phenomenon in which no local density irregularities having similar colors are generated, portions which are not covered with ink remain on the surface of a recording medium, and the surface thereof has a rough and grainy touch.

In addition, in this embodiment, as the recording medium described above, even when thin coated printing paper or the like having a metsuke of 73.3 to 104.7 g/m² is used, the generation of so-called curling in which a printed surface is curled inside can be suppressed.

Although the reason a high-quality image without having white streaks and rough touch can be realized by adding the alkanediol in which one carbon having a hydroxyl group has a side chain and the water-soluble alkanetriol as essential components as well as the slightly water-soluble alkanediol and the water-soluble 1,2-alkanediol has not been clearly understood, the following may be conceived.

The reason agglomeration of ink is generated when it is printed on coated printing paper is believed that since the surface tension of an ink dot is high, and a contact angle between the surface of the coated printing paper and an ink droplet is high, the coated printing paper repels the ink. Even in the case of recording at a low resolution in which white streaks and filling failure may occur, the agglomeration of ink can be suppressed when the surface tension of ink adhering to the surface of coated printing paper is reduced.

In addition, the reason white streaks and filling failure are generated in recording at a low resolution is believed that ink dots adhering to the surface of coated printing paper are brought into contact with adjacent ink dots and wet-spread to each other, and the undried ink flows among the ink dots. This ink flow among the ink dots may be caused by the difference in drying time between ink dots due to the difference in adhering time between adjacent ink dots, the difference in size of droplets at the time of adhesion, and the like. Hence, in order to suppress agglomeration of ink and to realize a high-quality image without having white streaks and rough touch even when printing is performed at a low resolution, it is believed that an ink having a low surface tension and a low fluidity is preferably allowed to adhere to coated printing paper.

However, unless a permeable wetting agent is used in order to decrease the fluidity of ink, since drying of ink droplets adhering to the surface of coated printing paper is accelerated, and the absorption of ink is also accelerated, the time for ink droplets adhering to each other to wet-spread is not ensured, and as a result, it is believed that in recording at a low resolution, white streaks and filling failure occur.

The alkanediol in which one carbon having a hydroxyl group has a side chain and the water-soluble alkanetriol used in this embodiment are materials having viscous properties similar to that of glycerin. In addition, the alkanediol in which one carbon having a hydroxyl group has a side chain and the water-soluble alkanetriol are permeable wetting agents each having a lower surface tension than that of glycerin. For example, the surface tension of an aqueous solution containing 3-methyl-1,3,5-pentanetriol at a concentration of 10% is 47.5 mN/m, and the surface tension of an aqueous solution containing 3-methyl-1,3-butanediol at a concentration of 10% is 52.6 mN/m.

When the alkanediol in which one carbon having a hydroxyl group has a side chain and the water-soluble alkanetriol, which have the properties as described above, are used together with the above-described slightly water-soluble alkanediol and water-soluble 1,2-alkanediol, the ejection stability is improved. The ejection stability is improved as the length of an alkyl chain of the alkanediol in which one carbon having a hydroxyl group has a side chain and that of an alkyl chain of the water-soluble alkanetriol are decreased.

In addition, although the reason the generation of curling is suppressed when the alkanediol in which one carbon having a hydroxyl group has a side chain and the water-soluble alkanetriol are added as essential components together with the slightly water-soluble alkanediol and water-soluble 1,2-alkanediol has not been clearly understood, the following may be conceived.

The water-soluble 1,2-alkanediol is a polar solvent and is a resin-film forming agent. It is believed that when the above function is inhibited, film-formation shrinkage of resin can be prevented. In order to inhibit this function, a weak polar solvent is preferably used. In addition, since a non-polar solvent has a very low affinity to resin, the inhibition effect may not be obtained. As the weak polar solvent, a solvent may be preferably used in which one carbon atom has an alkyl group having a +I effect and a hydroxyl group having a −I effect at the same time. It is believed that the alkanediol in which one carbon having a hydroxyl group has a side chain inhibits the film-formation shrinkage caused by the water-soluble 1,2-alkanediol and that under this condition, the generation of curling is suppressed by a drying retardation effect of the water-soluble alkanetriol.

In this embodiment, as the slightly water-soluble alkanediol, an alkanediol having at least 7 carbon atoms is preferable, and an alkanediol having 7 to 10 carbon atoms is more preferable. For example, as the slightly water-soluble alkanediol, there may be mentioned 1,2-heptanediol, 1,2-octanediol, 5-methyl-1,2-hexanediol, 4-methyl-1,2-hexanediol, or 4,4-dimethyl-1,2-pentanediol. Among those mentioned above, 1,2-octanediol is more preferable.

In addition, as the water-soluble 1,2-alkanediol, an alkanediol having 6 carbon atoms or less is preferable, and for example, there may be mentioned 1,2-hexanediol, 1,2-pentanediol, 1,2-butanediol, 4-methyl-1,2-pentanediol, or 3,3-dimethyl-1,2-butanediol. Among those mentioned above, a water-soluble alkanediol having a surface tension of 28 mN/m or less in the form of a 15% aqueous solution is more preferable, and 1,2-hexanediol (surface tension: 26.7 mN/m), 4-methyl-1,2-pentanediol (surface tension: 25.4 mN/m), or 3,3-dimethyl-1,2-butanediol (surface tension: 26.1 mN/m) is particularly preferable. In consideration of order during printing, 1,2-hexanediol is preferable.

In addition, as the alkanediol in which one carbon having a hydroxyl group has a side chain used in this embodiment, for example, 3-methyl-1,3-butanediol may be mentioned.

Furthermore, in this embodiment, as the water-soluble alkanetriol, for example, 1,2,6-hexanetriol or 3-methyl-1,3,5-pentantriol may be mentioned.

In addition, as a dissolving agent for the slightly water-soluble alkanediol, the alkanediol in which one carbon having a hydroxyl group has a side chain and the water-soluble alkanetriol may be used in combination.

In the four types of alcoholic solvents described above, the content ratio of the slightly water-soluble alkanediol to the water-soluble 1,2-alkanediol is preferably in the range of 6:1 to 1:3 and is more preferably in the range of 6:1 to 1:1. Within the range described above, the slightly water-soluble alkanediol can be stably dissolved in ink, and as a result, the ejection stability is improved. On the other hand, when the ratio of the water-soluble 1,2-alkanediol is increased than the range described above, a decrease in ink initial viscosity and suppression in agglomeration irregularities are not easily achieved at the same time. In addition, when the ratio of the water-soluble 1,2-alkanediol is smaller than the above range, it becomes difficult to stably dissolve the slightly water-soluble alkanediol in ink, and it also becomes difficult to suppress the change in viscosity with time and to maintain the storage stability.

In addition, the content ratio of the slightly water-soluble alkanediol to the total of the alkanediol in which one carbon having a hydroxyl group has a side chain and the water-soluble alkanetriol is preferably in the range of 1:1 to 1:18 and is more preferably in the range of 1:1 to 1:6. Within the range described above, the ink initial viscosity can be decreased, and good clogging recovery properties can also be realized. On the other hand, when the ratio of the total of the alkanediol in which one carbon having a hydroxyl group has a side chain and the water-soluble alkanetriol is increased than the range described above, the ink initial viscosity is increased, and drying properties are degraded. In addition, when the ratio of the total of the alkanediol in which one carbon having a hydroxyl group has a side chain and the water-soluble alkanetriol is smaller than the range described above, the clogging recovery properties are degraded, and the drying properties are enhanced, the time for ink to wet-spread cannot be ensured; hence, the ink may not be able to cover a recording medium, and white streaks are liable to occur.

In addition, the content ratio of the water-soluble 1,2-alkanediol to the total of the alkanediol in which one carbon having a hydroxyl group has a side chain and the water-soluble alkanetriol is preferably in the range of 1:1 to 1:36 and is more preferably in the range of 1:1 to 1:18. Within the range described above, when printing is performed on coated printing paper at a low resolution, the generation of white streaks and rough touch can be further suppressed. On the other hand, when the ratio of the water-soluble 1,2-alkanediol is increased than the range described above, the ink initial viscosity is increased, and the drying properties are degraded. In addition, when the ratio of the total of the alkanediol in which one carbon having a hydroxyl group has a side chain and the water-soluble alkanetriol is smaller than the range described above, the clogging recovery properties are degraded, and the drying properties are enhanced; hence, the time for ink to wet-spread cannot be ensured, and the ink may not be able to cover a recoding medium, so that white streaks are liable to occur.

Furthermore, the content ratio of the alkanediol in which one carbon having a hydroxyl group has a side chain to the water-soluble alkanetriol is preferably in the range of 3:1 to 1:3 and is more preferably in the range of 2:1 to 1:2. Within the range described above, the generation of curling can be further suppressed. However, when the ratio of the alkanediol in which one carbon having a hydroxyl group has a side chain is increased than the range described above, since the initial viscosity is further decreased, a flying speed of ink can be increased, and droplet landing accuracy is improved; hence, it is more preferable. In addition, it is more preferable since the slightly water-soluble alkanediol can be stably dissolved. On the other hand when the ratio of the alkanediol in which one carbon having a hydroxyl group has a side chain is smaller than the range described above, since the effect of inhibiting film-formation shrinkage caused by the water-soluble 1,2-alkanediol is degraded, the effect of suppressing the generation of curling is not likely to be obtained.

In addition, the content ratio of the water-soluble 1,2-alkanediol to the alkanediol in which one carbon having a hydroxyl group has a side chain is preferably in the range of 1:1 to 1:12 and is more preferably in the range of 1:1 to 1:6. Within the range described above, when printing is performed on coated printing paper at a low resolution, the generation of white streaks and rough touch can be further suppressed. On the other hand, when the ratio of the water-soluble 1,2-alkanediol is increased than the range described above, the ink initial viscosity is increased, and the drying properties are degraded. In addition, when the ratio of the alkanediol in which one carbon having a hydroxyl group has a side chain is smaller than the range described above, the clogging recovery properties are degraded, and the drying properties are enhanced; hence, since the time for ink to wet-spread cannot be ensured, the ink may not be able to cover a recording medium, and white streaks are liable to occur.

Furthermore, in this embodiment, the total content of the slightly water-soluble alkanediol and the water-soluble 1,2-alkanediol is preferably 6 percent by weight or less to the ink composition. Within the range described above, agglomeration irregularities are not generated on a recording medium, such as coated printing paper, having low ink absorbing properties, and in addition, the ejection stability is also superior.

In addition, in this embodiment, the total content of the slightly water-soluble alkanediol, the alkanediol in which one carbon having a hydroxyl group has a side chain, and the water-soluble alkanetriol is preferably 21 percent by weight or less to the ink composition. Within the range described above, agglomeration irregularities are not generated on a recording medium, such as coated printing paper, having low ink absorbing properties, and in addition, the ejection stability and curling suppression are also improved.

The content of the slightly water-soluble alkanediol is preferably in the range of 1 to 3 percent by weight and is more preferably in the range of 1.5 to 2.5 percent by weight to the total ink composition. When the content is less than 1 percent by weight, printing irregularities may be generated in some cases on a recording medium, such as coated printing paper, having low ink absorbing properties. On the other hand, when the content is more than 3 percent by weight, the slightly water-soluble alkanediol may not be completely dissolved in ink in some cases.

The content of the water-soluble 1,2-alkanediol is preferably in the range of 0.5 to 6 percent by weight and is more preferably in the range of 0.5 to 3 percent by weight. When the content is less than 0.5 percent by weight, the slightly water-soluble alkanediol may not be dissolved in ink in some cases. On the other hand, when the content is more than 6 percent by weight, the ink initial viscosity may be increased in some cases, and hence it is not preferable.

The total content of the alkanediol in which one carbon having a hydroxyl group has a side chain and the water-soluble alkanetriol is preferably in the range of 3 to 18 percent by weight to the total ink composition and is more preferably in the range of 4 to 8 percent by weight. When the content is less than 3 percent by weight, in printing on coated printing paper at a low resolution, white streaks and rough touch may be generated in some cases. On the other hand, when the content is more than 18 percent by weight, the drying properties of a printed matter immediately after printing may be degraded in some cases.

The content of the alkanediol in which one carbon having a hydroxyl group has a side chain is preferably in the range of 2 to 12 percent by weight to the total ink composition and is more preferably in the range of 3 to 6 percent by weight.

The content of the water-soluble alkanetriol is preferably in the range of 2 to 12 percent by weight to the total ink composition and is more preferably in the range of 3 to 6 percent by weight.

### Colorant

As the colorant used in the ink composition for ink jet recording according to this embodiment, either a dye or a pigment may be used; however, in consideration of light resistance and water resistance, a pigment is preferably used.

As the pigment, for example, an inorganic pigment and an organic pigment may be mentioned, and they may be used alone or in combination. As the inorganic pigment, for example, besides titanium oxide and iron oxide, carbon black produced by a known method, such as a contact method, a furnace method, or a thermal method may also be used. In addition, as the organic pigment, for example, an azo pigment (such as an azo lake, an insoluble azo pigment, a condensed azo pigment, or a chelate azo pigment), a polycyclic pigment (such as a phthalocyanine pigment, a perylene pigment, a perynone pigment, an anthraquinone pigment, a quinacridone pigment, a dioxazine pigment, a thioindigo pigment, an isoindolinone pigment, or a quinofuralone pigment), a dye chelate (such as a basic dye chelate or an acidic dye chelate), a nitro pigment, a nitroso pigment, or aniline black may be used.

Particular examples of the pigments may be mentioned in accordance with the type (color) of an ink composition to be obtained. For example, as a pigment for a yellow ink composition, there may be mentioned C.I. Pigment Yellow 1, 2, 3, 12, 14, 16, 17, 73, 74, 75, 83, 93, 95, 97, 98, 109, 110, 114, 128, 129, 138, 139, 147, 150, 151, 154, 155, 180, and 185, and those mentioned above may be used alone or in combination. In particular, among those pigments, at least one selected from the group consisting of C.I. Pigment Yellow 74, 110, 128 and 147 may be preferably used. In addition, as a pigment for a magenta ink composition, for example, there may be mentioned C.I. Pigment Red 5, 7, 12, 48(Ca), 48(Mn), 57(Ca), 57:1, 112, 122, 123, 168, 184, 202, and 209, as well as C.I. Pigment Violet 19, and those mentioned above may be used alone or in combination. In particular, among those mentioned above, at least one selected from the group consisting of C.I. Pigment Red 122, 202, and 209, as well as C.I. Pigment Violet 19 is preferably used. In addition, as a pigment for a cyan ink composition, for example, there may be mentioned C.I. Pigment Blue 1, 2, 3, 15:3, 15:4, 15:34, 16, 22, and 60, as well as C.I. Vat Blue 4 and 60, and those mentioned above may be used alone or in combination. In particular, among those mentioned above, C.I. Pigment Blue 15:3 and/or 15:4 is preferably used, and C.I. Pigment Blue 15:3 is especially preferably used.

As a pigment for a black ink composition, for example, inorganic pigments, such as carbons including lamp black (C.I. Pigment 6), acetylene black, furnace black (C.I. Pigment Black 7), channel black (C.I. Pigment Black 7), and carbon black (C.I. Pigment Black 7), and iron oxide pigments; and organic pigments such as aniline black (C.I. Pigment Black 1) may be mentioned. In this embodiment, carbon blacks are preferably used. As particular examples of carbon blacks, for example, there may be mentioned #2650, #2600, #2300, #2200, #1000, #980, #970, #966, #960, #950, #900, #850, MCF-88, #55, #52, #47, #45, #45L, #44, #33, #32, #30 (manufactured by Mitsubishi Chemical Corporation), SpecialBlaek4A, 550, Printex95, 90, 85, 80, 75, 45, 40 (manufactured by Degussa Corporation), Rega1660, Rmogu1L, monarch1400, 1300, 1100, 800, 900 (manufactured by Cabot Corporation), Raven7000, 5750, 5250, 3500, 2500ULTRA, 2000, 1500, 1255, 1200, 1190ULTRA, 1170, 1100ULTRA, and Raven5000UIII (manufactured by Columbian Corporation).

Since the concentration (content) of the pigment may be appropriately adjusted when an ink composition is prepared, it is not particularly limited; however, in this embodiment, a solid component concentration of pigment is preferably set to 6 percent by weight or more and is more preferably set to 12 percent by weight or more. When an ink droplet adheres to a recording medium, the ink wet-spreads on the surface thereof; however, when the pigment solid concentration is set to high such as 6 percent by weight or more, the fluidity of the ink is lost at an early stage after the wet-spreading stops. Hence, when printing is performed on a recording medium, such as coated printing paper, at a low resolution, bleeding can be further suppressed. That is, it is believed that by using the specific four types of alcoholic solvents described above in combination, ink wet-spreads even on a recording medium having low ink absorption properties and, in addition, that by increasing the solid component concentration of ink, the fluidity thereof on a recording medium is decreased, and hence bleeding can be suppressed. In particular, at a boundary in a recording medium between a portion of a small ink adhesion amount and a portion of a large ink adhesion amount, a bleeding suppression effect is significant.

The pigment described above is preferably a pigment processed by a compounding treatment with a dispersant which will be described later since image gloss, bronzing prevention, and storage stability of an ink composition can be simultaneously satisfied, and since a color image having more superior gloss can also be formed.

### Dispersant

The ink composition of this embodiment preferably includes at least one resin selected from the group consisting of a styrene-acrylic acid copolymer resin, a urethane resin, and a fluorene resin as a dispersant for dispersing the colorant. The copolymer resin mentioned above adheres to a pigment to improve the dispersibility.

As a particular example of a hydrophobic monomer of the copolymer resin, for example, there may be mentioned methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, sec-butyl acrylate, sec-butyl methacrylate, tert-butyl acrylate, tert-butyl methacrylate, n-hexyl acrylate, n-hexyl methacrylate, n-octyl acrylate, n-octyl methacrylate, iso-octyl acrylate, iso-octyl methacrylate, 2-ethylhexyl acrylate, 2-ethylhexyl methacrylate, decyl acrylate, decyl methacrylate, lauryl acrylate, lauryl methacrylate, stearyl acrylate, stearyl methacrylate, 2-hydroxyethyl acrylate, 2-hydroxyethyl methacrylate, 2-hydroxypropyl acrylate, 2-hydroxypropyl methacrylate, 2-dimethylaminoethyl acrylate, 2-dimethylaminoethyl methacrylate, 2-diethylaminoethyl acrylate, 2-diethylaminoethyl methacrylate, glycidyl acrylate, glycidyl methacrylate, allyl acrylate, allyl methacrylate, cyclohexyl acrylate, cyclohexyl methacrylate, phenyl acrylate, phenyl methacrylate, nonylphenyl acrylate, nonylphenyl methacrylate, benzyl acrylate, benzyl methacrylate, dicyclopentenyl acrylate, dicyclopentenyl methacrylate, bornyl acrylate, bornyl methacrylate, 1,3-butanediol diacrylate, 1,3-butanediol dimethacrylate, 1,4-butanediol diacrylate, 1,4-butanediol dimethacrylate, ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, polyethylene glycol diacrylate, polyethylene glycol dimethacrylate, neopentyl glycol diacrylate, 1,6-hexanediol diacrylate, 1,6-hexanediol dimethacrylate, dipropylene glycol diacrylate, dipropylene glycol dimethacrylate, trimethylolpropane triacrylate, trimethylolpropane trimethacrylate, glycerol acrylate, glycerol methacrylate, styrene, methyl styrene, and vinyltoluene. These monomers mentioned above may be used alone or in combination.

As a particular example of a hydrophilic monomer, for example, acrylic acid, methacrylic acid, maleic acid, or itaconic acid may be mentioned.

As a copolymer resin between the hydrophobic monomer and the hydrophilic monomer which can simultaneously satisfy the gloss of a color image, bronzing prevention, and storage stability of an ink composition, and which can also form a color image having a more superior gloss, for example, at least one of a styrene-(meth)acrylic acid copolymer resin, a styrene-methyl styrene-(meth)acrylic acid copolymer resin, a styrene-maleic acid copolymer resin, a (meth)acrylic acid-(meth)acrylate copolymer resin, and a styrene-(meth)acrylic acid-(meth)acrylate copolymer resin may be preferably used.

The copolymer resin may be a resin (styrene-acrylic acid resin) including a polymer obtained by a reaction between styrene and acrylic acid or an acrylic ester. Alternatively, the copolymer resin may be an acrylic acid-based water-soluble resin. Furthermore, the copolymer resin may be a salt of the resin mentioned, for example, in the form of sodium, potassium, or ammonium salt.

The content of the copolymer resin is preferably in the range of 20 to 50 parts by weight with respect to 100 parts by weight and is more preferably in the rang of 20 to 40 parts by weight since the gloss of a color image, bronzing prevention, and storage stability of an ink composition are simultaneously satisfied and, in addition, since a color image having more superior gloss can also be formed.

In addition, in this embodiment, by using a urethane resin as a pigment dispersant, the gloss of a color image, bronzing prevention, and storage stability of an ink composition can be simultaneously satisfied and, in addition, a color image having more superior gloss can also be formed. The urethane resin is a resin including a polymer formed by a reaction between a diisocyanate compound and a diol compound, and in this embodiment, a resin having a urethane bond and/or an amide bond and an acidic group is preferable.

As the diisocyanate compound, for example, there may be mentioned an aliphatic diisocyanate compound, such as hexamethylene diisocyanate or 2,2,4-trimethylhexamethylene diisocyanate; an aromatic diisocyanate compound, such as tolylene diisocyanate or phenylmethane diisocyanate; and a modified compound thereof.

As the diol compound, for example, there may be mentioned a polyether compound, such as a poly(ethylene glycol) or a poly(propylene glycol); a polyester compound, such as a poly(ethylene adipate) or a poly(butylene adipate); or a polycarbonate compound.

The urethane resin preferably has a carboxyl group.

In addition, in this embodiment, as the pigment dispersant, a fluorene resin may also be used.

The weight ratio of the copolymer resin to the urethane resin (former/latter) is preferably in the range of 1/2 to 2/1, and since the gloss of a color image, bronzing prevention, and storage stability of an ink composition can be simultaneously satisfied, and since a color image having more superior gloss can also be formed, the ratio is more preferably in the range of 1/1.5 to 1.5/1.

The weight ratio of the solid component of the pigment to that of other than the pigment (former/latter) is preferably in the range of 100/20 to 100/80 since the gloss of a color image, bronzing prevention, and storage stability of an ink composition can be simultaneously satisfied, and since a color image having more superior gloss can also be formed.

Since the gloss of a color image, bronzing prevention, and storage stability of an ink composition can be simultaneously satisfied, and a color image having more superior gloss can also be formed, the content of the copolymer resin with respect to 100 parts by weight of the pigment is preferably in the range of 20 to 50 parts by weight and is more preferably in the range of 20 to 40 parts by weight.

Since the gloss of a color image, bronzing prevention, and storage stability of an ink composition can be simultaneously satisfied, and a color image having more superior gloss can also be formed, the content of the urethane resin with respect to 100 parts by weight of the pigment is preferably in the range of 10 to 40 parts by weight and is more preferably in the range of 10 to 35 parts by weight.

Since the gloss of a color image, bronzing prevention, and storage stability of an ink composition can be simultaneously satisfied, and a color image having more superior gloss can also be formed, the content of the fluorene resin with respect to 100 parts by weight of the pigment is preferably in the range of 20 to 100 parts by weight and is more preferably in the range of 20 to 80 parts by weight.

Since the gloss of a color image, bronzing prevention, and storage stability of an ink composition can be simultaneously satisfied, and a color image having more superior gloss can also be formed, the total content of the copolymer resin and the urethane resin with respect to 100 parts by weight of the pigment is preferably set to 90 parts by weight or less (more preferably set to 70 parts by weight or less).

Since the gloss of a color image, bronzing prevention, and storage stability of an ink composition can be simultaneously satisfied, and a color image having more superior gloss can also be formed, the acid value of the copolymer resin is preferably in the range of 50 to 320 and is more preferably in the range of 100 to 250.

Since the gloss of a color image, bronzing prevention, and storage stability of an ink composition can be simultaneously satisfied, and a color image having more superior gloss can also be formed, the acid value of the urethane resin is preferably in the range of 10 to 300 and is more preferably in the range of 20 to 100. Incidentally, the acid value indicates the amount of KOH on a milligram basis that is required to neutralize 1 gram of a resin.

Since the gloss of a color image, bronzing prevention, and storage stability of an ink composition can be simultaneously satisfied, and a color image having more superior gloss can also be formed, the weight average molecular weight (Mw) of the copolymer resin is preferably in the range of 2,000 to 30,000 and is more preferably in the range of 2,000 to 20,000.

Since the gloss of a color image, bronzing prevention, and storage stability of an ink composition can be simultaneously satisfied, and a color image having more superior gloss can also be formed, the weight average molecular weight (Mw) of the urethane resin before crosslinking is preferably in the range of 100 to 200,000 and is more preferably in the range of 1,000 to 50,000. For example, Mw is measured by gel permeation chromatography (GPC).

Since the gloss of a color image, bronzing prevention, and storage stability of an ink composition can be simultaneously satisfied, and a color image having more superior gloss can also be formed, the glass transition temperature (Tg: measured in accordance with JIS K6900) of the copolymer resin is preferably 30° C. or more and is more preferably in the range of 50 to 130° C.

Since the gloss of a color image, bronzing prevention, and storage stability of an ink composition can be simultaneously satisfied, and a color image having more superior gloss can also be formed, the glass transition temperature (Tg: measured in accordance with JIS K6900) of the urethane resin is preferably in the range of −50 to 200° C. and is more preferably in the range of −50 to 100° C.

The copolymer resin may adhere to the pigment in a pigment dispersion or may be freely dispersed therein. Since the gloss of a color image, bronzing prevention, and storage stability of an ink composition can be simultaneously satisfied, and a color image having more superior gloss can also be formed, the maximum particle diameter of the copolymer resin is preferably 0.3 μm or less, and the average particle diameter thereof is more preferably 0.2 μm or less (even more preferably 0.1 μm or less). In this embodiment, the average particle diameter is the average of distribution diameters (accumulative 50% diameter) of the pigment in the form of particles actually dispersed in a dispersion and, for example, the average particle diameter can be measured using Microtrack UPA (manufactured by Microtrack Inc.).

In addition, as the fluorene resin described above, any resin may be used as long as it has a fluorene structure, and for example, the fluorene resin may be obtained by copolymerizing the following monomer units.

Cyclohexane, 5-isocyanate-1-(isocyanatemethyl)-1,3,3-trimethyl (CAS No. 4098-71-9)

Ethanol, 2,2′[9H-fluorene-9-ylidenebis(4,1-phenyleneoxy)]bis (CAS No. 117344-32-8)

Propionic acid and 3-hydroxy-2-(hydroxymethyl)-2-methyl (CAS No. 4767-03-7)

Ethanamine, N,N-diethyl- (CAS No. 121-44-8)

In addition, as the dispersant, a surfactant may also be used. As the surfactant, for example, there may be mentioned an anionic surfactant, such as a fatty acid salt, a higher alkyl dicarboxylate, a higher alcohol sulfate, a higher alkyl sulfonate, a condensation between a higher fatty acid and an amino acid, a sulfosuccinate, a naphthenate, a liquid fatty oil sulfate, or an alkylaryl sulfonate; a cationic surfactant such as a fatty acid amine salt, a quaternary ammonium salt, a sulfonium salt, or phosphonium; or a nonionic surfactant such as a polyoxyethylene alkyl ether, a polyoxyethylene alkyl ester, a sorbitan alkyl ester, or a polyoxyethylene sorbitan alkyl ester. When the surfactant mentioned above is added to an ink composition, of course, it functions as a surfactant.

### Surfactant

The ink composition for ink jet printing of this embodiment includes the surfactant as an essential component. By using the surfactant on a material used as a recording medium, the surface of which is coated with a resin to receive ink, an image having superior gloss can be realized even on a recording medium, such as photographic paper, in which a glossy feeling is more important. In particular, even when a recording medium, such as coated printing paper, having a coated layer to receive an oil-based ink in a reception layer provided as the surface of the medium is used, the use of the surfactant can prevent bleeding between colors and whitening caused by reflected light which occurs concomitant with an increase in adhesion amount of ink.

As the surfactant used in this embodiment, an organopolysiloxane-based surfactant is preferably used, and this surfactant can improve the wettability to the surface of a recording medium when a recording image is formed thereon, so that permeability of ink is improved. When an organopolysiloxane-based surfactant is used, since the four types of alcoholic solvents are used as described above, the solubility of the surfactant in ink is improved, and an insoluble substance and the like are prevented from being generated, so that an ink composition having more excellent ejection stability can be realized.

As the surfactant described above, a commercially available surfactant may be used, and for example, OLFINE PD-501, OLFINE PD-502, and OLFINE PD-570 (those are all manufactured by Nissin Chemical Industry Co., Ltd.) may be used.

In addition, as the organopolysiloxane-based surfactant, at least one compound represented by the following formula (I) is more preferably contained.

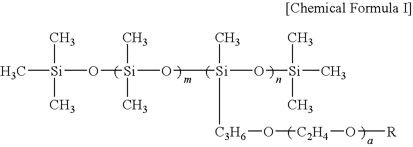

In the above formula, R indicates a hydrogen atom or a methyl group, a indicates an integer of 2 to 11, m indicates an integer of 2 to 50, and n indicates an integer of 1 to 5. Alternatively, at least one compound is more preferably contained in which in the above formula (I), R indicates a hydrogen atom or a methyl group, a indicates an integer of 2 to 13, m indicates an integer of 2 to 50, and n indicates an integer of 1 to 5. In addition, at least one compound is more preferably contained in which in the above formula (I), R indicates a hydrogen atom or a methyl group, a indicates an integer of 2 to 13, m indicates an integer of 2 to 50, and n indicates an integer of 1 to 8. Alternatively, at least one compound is more preferably contained in which in the above formula (I), R indicates a methyl group, a indicates an integer of 6 to 18, m indicates 0, and n indicates 1. By using the particular organopolysiloxane-based surfactants described above, even when printing is performed on coated printing paper used as a recording medium, agglomeration irregularities of ink can be further reduced.

In accordance with the above formula (I), a compound in which a indicates an integer of 2 to 5, m indicates an integer of 20 to 40, and n indicates an integer of 2 to 4, a compound in which a indicates an integer of 7 to 11, m indicates an integer of 30 to 50, and n indicates an integer of 3 to 5, a compound in which a indicates an integer of 9 to 13, m indicates an integer of 2 to 4, and n indicates an integer of 1 or 2, or a compound in which a indicates an integer of 6 to 10, m indicates an integer of 10 to 20, and n indicates an integer of 4 to 8 is more preferably used. By using the compound described above, agglomeration irregularities of ink can be further reduced.

In accordance with the above formula (I) in which R indicates a hydrogen atom, a compound in which a indicates an integer of 2 to 5, m indicates an integer of 20 to 40, and n indicates an integer of 2 to 4, or a compound in which a indicates an integer of 7 to 11, m indicates an integer of 30 to 50, and n indicates an integer of 3 to 5 is more preferably used. By using the compound described above, agglomeration irregularities of ink and bleeding thereof can be further reduced.

In accordance with the above formula (I) in which R indicates a methyl group, a compound in which a indicates an integer of 9 to 13, m indicates an integer of 2 to 4, and n indicates an integer of 1 or 2, or a compound in which a indicates an integer of 6 to 10, m indicates an integer of 10 to 20, and n indicates an integer of 4 to 8 is more preferably used. By using the compound described above, agglomeration irregularities of ink and bleeding thereof can be further reduced.

Furthermore, in the above formula (I), a compound in which R indicates a methyl group, a indicates an integer of 6 to 12, m indicates 0, and n indicates 1 is more preferably used. By using the compound described above, agglomeration irregularities of ink and bleeding thereof can be further reduced.

In addition, in accordance with the above formula (I), a mixture is most preferably used which includes a compound in which R indicates a hydrogen atom, a indicates an integer of 7 to 11, m indicates an integer of 30 to 50, and n indicates an integer of 3 to 5, a compound in which R indicates a methyl group, a indicates an integer of 9 to 13, m indicates an integer of 2 to 4, and n indicates an integer of 1 or 2, and a compound in which R indicates a methyl group, a indicates an integer of 6 to 10, m indicates an integer of 10 to 20, and n indicates an integer of 4 to 8. By using the mixture described above, agglomeration irregularities of ink and bleeding thereof can be further significantly reduced.

The surfactant described above is included in the ink composition of this embodiment preferably in an amount of 0.01 to 1.0 percent by weight and more preferably in an amount of 0.05 to 0.50 percent by weight. In addition, the surfactant in which R indicates a methyl group and the surfactant in which R indicates a hydrogen atom are more preferably used in combination since small font letters are not blurred. In particular, when the surfactant in which R indicates a methyl group is used, the content of which is preferably set larger than that in the case in which the surfactant in which R indicates a hydrogen atom is used in terms of agglomeration irregularities.

Furthermore, with respect to the content of the surfactant in which R indicates a methyl group, the content of the surfactant in which R indicates a hydrogen atom is more preferably increased. As a result, even in coated printing paper, such as cast coated paper, which is liable to repel ink, and which has a slow permeation speed, agglomeration of ink and bleeding thereof can be reduced.

The ink composition of this embodiment may further include another surfactant, such as an acetylene glycol-based surfactant, an anion surfactant, a nonion surfactant, or an ampholytic surfactant.

Among those mentioned above, as the acetylene glycol-based surfactant, for example, 2,4,7,9-tetramethyl-5-decyne-4,7-diol, 3,6-dimethyl-4-octyne-3,6-diol, 3,5-dimethyl-1-hexyne-3-ol, and 2,4-dimethyl-5-hexyne-3-ol may be mentioned. As the acetylene glycol-based surfactant, a commercially available surfactant may also be used, and for example, OLFINE E1010, STG, Y (trade name, manufactured by Nissin Chemical Industry Co., Ltd.), and Surfynol 61, 104, 82, 465, 485, and TG (trade name, manufactured by Air Products and Chemicals Inc.) may be mentioned.

### Water and Other Components

The ink composition for ink jet recording of this embodiment includes the water as a solvent as well as the above-described specific alcoholic solvents, the surfactant, and the other various additives. As the water, pure water or ultrapure water, such as ion-exchanged water, ultrafiltration water, reverse osmosis water, or distilled water, is preferably used. In particular, these types of water are preferably subjected to a sterilization treatment such as ultraviolet radiation or addition of hydrogen peroxide since generation of fungi and bacteria is prevented for a long period of time.

In addition, the ink composition of this embodiment preferably further includes a permeating agent as well as the components described above.

As the permeating agent, glycol ethers are preferably used.

As particular examples of glycol ethers, for example, there may be mentioned ethylene glycol monomethyl ether, ethylene glycol monoethyl ether, ethylene glycol mono-iso-propyl ether, ethylene glycol mono-n-butyl ether, ethylene glycol mono-iso-butyl ether, ethylene glycol mono-tert-butyl ether, ethylene glycol monomethyl ether acetate, diethylene glycol monomethyl ether, diethylene glycol monoethyl ether, diethylene glycol mono-n-propyl ether, diethylene glycol mono-iso-propyl ether, diethylene glycol mono-n-butyl ether, diethylene glycol mono-tert-butyl ether, triethylene glycol mono-n-butyl ether, propylene glycol monomethyl ether, propylene glycol monoethyl ether, propylene glycol mono-n-propyl ether, propylene glycol mono-iso-propyl ether, propylene glycol mono-n-butyl ether, propylene glycol mono-tert-butyl ether, dipropylene glycol monomethyl ether, dipropylene glycol monoethyl ether, dipropylene glycol mono-n-propyl ether, dipropylene glycol-iso-propyl ether, dipropylene glycol mono-n-butyl ether, dipropylene glycol mono-tert-butyl ether, and 1-methyl-1-methoxybutanol. These glycol ethers may be used alone or in combination.

Among the glycol ethers described above, alkyl ethers of polyalcohols are preferable, and in particular, ethylene glycol monoethyl ether, ethylene glycol mono-n-butyl ether, diethylene glycol monomethyl ether, diethylene glycol monoethyl ether, diethylene glycol mono-n-butyl ether, propylene glycol monomethyl ether, propylene glycol monoethyl ether, propylene glycol monobutyl ether, triethylene glycol monomethyl ether, triethylene glycol monoethyl ether, or triethylene glycol mono-n-butyl ether is preferable. In addition, triethylene glycol mono-n-butyl ether is more preferable.

Although the addition amount of the permeating agent may be arbitrarily determined, the amount is preferably in the range of approximately 0.1 to 30 percent by weight and is more preferably in the range of approximately 1 to 20 percent by weight.

In addition, the ink composition of this embodiment preferably further includes a recording-medium dissolving agent as well as the components described above.

As the recording-medium dissolving agent, a pyrrolidone, such as N-methyl-2-pyrrolidone is preferably used. Although the addition amount of the recording-medium dissolving agent may be arbitrarily determined, the amount is preferably in the range of approximately 0.1 to 30 percent by weight and is more preferably in the range of approximately 1 to 20 percent by weight.

In addition, in the ink composition for ink jet recording of this embodiment, it is preferable that a moistening agent is not substantially included. Since the moistening agent functions to prevent ink from being solidified by drying at an ink jet nozzle or the like, when ink is dripped to synthetic paper which has particularly low ink absorption properties, the ink may not be dried in some cases, so that a problem may arise in high speed printing. In addition, when an ink containing a moistening agent is used, in the state in which an ink droplet which is not absorbed remains on the surface of a recording medium, a next ink droplet adheres thereto, so that agglomeration irregularities may be generated in some cases.

Hence, in this embodiment, when a recording medium having particularly low ink absorption properties is used as described above, it is preferable that a moistening agent is not substantially included. In addition, even when ink is dried and solidified at an ink jet nozzle, by using a solution containing a moistening agent, a solidified ink may be resolved.

In particular, in this embodiment, it is preferable that a moistening agent having a vapor pressure of 2 mPa or less at 25° C. is not substantially included. The above “not substantially contained” indicates that the addition amount of the moistening agent is less than 1 percent by weight with respect to the ink composition.

When the content of the moistening agent having a vapor pressure of 2 mPa or less at 25° C. is less than 1 percent by weight with respect to ink, printing can be performed by an ink jet recording method not only on a recording medium, such as coated printing paper, having low ink absorbing properties, but also on a metal or a plastic having no ink absorbing properties. In addition, it is obvious to those skilled in the art that some of the above permeating agents also function as a moistening agent; however, it is understood in this specification that the permeating agents described above are not categorized as the moistening agent. In addition, it is understood also in this specification that the alcoholic solvents described above are not categorized as the moistening agent.

The moistening agent of this specification is a moistening agent used in general ink for ink jet recording, and for example, there may be mentioned glycerin, ethylene glycol, water-soluble alkanediols having 3 to 5 carbon atoms, such as 1,3-propanediol, 3-methyl-1,3-butanediol, 1,3-butanediol, and 1,2-pentanediol, trimethylolpropane, trimethylolmethane, and trimethylolethane. For example, when coated printing paper having low ink absorption properties is used as a recording medium, the moistening agents mentioned above may be arbitrarily added.

The ink composition of this embodiment may further includes an agent for preventing nozzle clogging, a preservative, an antioxidant, a conductivity adjusting agent, a pH adjusting agent, a viscosity modifier, a surface tension adjusting agent, an oxygen absorbent, and/or the like.

As the preservative and a fungicide, for example, sodium benzoate, sodium pentachlorophenol, sodium 2-pyridinethiol-1-oxide, sodium sorbate, sodium dehydroacetate, and 1,2-dibenzynethiazoline-3-one (Proxel CRL, Proxel BND, Proxel GXL, Proxel XL-2, and Proxel TN manufactured by ICI Corporation) may be mentioned.

Furthermore, as the pH adjusting agent, another dissolving agent, and the antioxidant, for example, there may be mentioned amines such as diethanolamine, triethanolamine, propanolamine, and morpholine; modified compounds of the above amines; inorganic salts formed, for example, from potassium hydroxide, sodium hydroxide, and lithium hydroxide; ammonium compounds such as ammonium hydroxide and a quaternary ammonium hydroxide (such as tetramethylammonium); carbonates such as potassium carbonate, sodium carbonate, and lithium carbonate; phosphates; N-methyl-2-pyrrolidone; ureas such as urea, thiourea, and tetramethylurea; allophanates such as allophanate and methylallophanate; biurets such as biuret, dimethylbiuret, and tetramethylbiuret; and L-ascorbic acid and salts thereof.

In addition, the ink composition of this embodiment may further includes an antioxidant and an ultraviolet absorber, and for example, there may be mentioned Tinuvin 328, 900, 1130, 384, 292, 123, 144, 622, and 770, Irgacor 252 and 153, Irganox 1010, 1076, and 1035, MD 1024, (manufactured by Ciba Specialty Chemicals), and a lanthanide oxide.

The ink composition of this embodiment may be manufactured by dispersing and mixing the components described above using an appropriate method. First, a pigment, a polymer dispersant, and water are mixed by an appropriate dispersing apparatus such as a ball mill, a sand mill, an attritor, a roll mill, an agitator mill, a Henschel mixer, a colloid mill, an ultrasonic homogenizer, a jet mill, or an Angmill to prepare a uniform pigment dispersion. Subsequently, a separately prepared resin (resin emulsion), water, a water-soluble organic solvent, sugar, a pH adjusting agent, a preservative, a fungicide, and the like are added to the dispersion and are fully dissolved therein to prepare an ink solution. The solution is sufficiently stirred and is then filtrated for removing coarse particles and foreign materials that cause clogging, so that an intended ink composition is obtained.

### Ink Jet Recording Method

An ink jet recording method according to this embodiment is a method in which droplets of the above ink composition are ejected so as to adhere to a recording medium for printing. In the recording method of this embodiment, synthetic paper or coated printing paper is preferably used as the recording medium. In particular, even when printing is performed at a low resolution, a high quality image without having white streaks or rough touch can be realized on art paper, high quality paper for POD (print on demand) application, or special paper for a laser printer. As the high quality paper for POD application, for example, Ricoh business coat gloss 100 (manufactured by Ricoh Company, Ltd.) may be mentioned. In addition, as the special paper for a laser printer, LPCCTA4 (manufactured by SEIKO EPSON CORPORATION) may be mentioned.

Hereinafter, this embodiment will be described in detail.

### Preparation of Ink Composition

In accordance with compositions shown in the following Tables 1 to 5, individual components were mixed together and were then filtrated using a 10-μm membrane filter, so that individual inks were prepared. In this embodiment, the styrene-acrylic acid resin in the table is a copolymer having a molecular weight of 1,600 and an acid value of 150. The urethane resin is a copolymer having a molecular weight of 6,000 and an acid value of 50. In addition, the fluorene resin contains a monomer having a fluorene structure represented by CAS No. 117344-32-8 at a monomer ratio of approximately 50 percent by weight and is a resin having a molecular weight of 3,300. In addition, the surfactant used in this embodiment is an organopolysiloxane-based surfactant and is obtained by mixing a compound represented by the above formula (I) in which R indicates a methyl group, a indicates an integer of 9 to 13, m indicates an integer of 2 to 4, and n indicates an integer of 1 or 2 and a compound represented by the above formula (I) in which R indicates a hydrogen atom, a indicates an integer of 7 to 11, m indicates an integer of 30 to 50, and n indicates an integer of 3 to 5.

Hereinafter, Tables 1 to 5 are shown.

TABLE 1

| | | EXAMPLE 1 | | | | EXAMPLE 2 | | | |
|---|---|---|---|---|---|---|---|---|---|
| | | INK SET 1 | | | | INK SET 2 | | | |
| COMPOSITION | | 1Y | 1M | 1C | 1K | 2Y | 2M | 2C | 2K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 28 | 28 | 28 | 5.6 | 28 | 28 | 28 | 5.6 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | — | — | — | — | — | — | — | — |
| | RESIN | | | | | | | | |
| ALCOHOLIC | 1,2- | 1 | 1 | 1 | 1 | 3 | 3 | 3 | 3 |
| SOLVENT | OCTANEDIOL | | | | | | | | |
| | 1,2- | 0.5 | 0.5 | 0.5 | 0.5 | 0.5 | 0.5 | 0.5 | 0.5 |
| | HEXANEDIOL | | | | | | | | |
| | 3-METHYL-1,3- | 3 | 3 | 3 | 3 | 3 | 3 | 3 | 3 |
| | BUTANEDIOL | | | | | | | | |
| | 1,2,6- | 1.5 | 1.5 | 1.5 | 1.5 | 1.5 | 1.5 | 1.5 | 1.5 |
| | HEXANETRIOL | | | | | | | | |
| SURFACTANT | | 0.1 | 0.1 | 0.1 | 0.1 | 0.1 | 0.1 | 0.1 | 0.1 |
| PURE WATER | | BALANCE | BALANCE | BALANCE | BALANCE | BALANCE | BALANCE | BALANCE | BALANCE |
| | | EXAMPLE 3 | | | | EXAMPLE 4 | | | |
| | | INK SET 3 | | | | INK SET 4 | | | |
| COMPOSITION | | 3Y | 3M | 3C | 3K | 4Y | 4M | 4C | 4K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 28 | 28 | 28 | 5.6 | 28 | 28 | 28 | 5.6 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | — | — | — | — | — | — | — | — |
| | RESIN | | | | | | | | |
| ALCOHOLIC | 1,2- | 1 | 1 | 1 | 1 | 3 | 3 | 3 | 3 |
| SOLVENT | OCTANEDIOL | | | | | | | | |
| | 1,2- | 3 | 3 | 3 | 3 | 3 | 3 | 3 | 3 |
| | HEXANEDIOL | | | | | | | | |
| | 3-METHYL-1,3- | 6 | 6 | 6 | 6 | 3 | 3 | 3 | 3 |
| | BUTANEDIOL | | | | | | | | |
| | 1,2,6- | 3 | 3 | 3 | 3 | 1.5 | 1.5 | 1.5 | 1.5 |
| | HEXANETRIOL | | | | | | | | |

| | | | | | | | | |
|---|---|---|---|---|---|---|---|---|
| SURFACTANT | 0.1 | 0.1 | 0.1 | 0.1 | 0.1 | 0.1 | 0.1 | 0.1 |
| PURE WATER | BALANCE | BALANCE | BALANCE | BALANCE | BALANCE | BALANCE | BALANCE | BALANCE |

TABLE 2

| | | EXAMPLE 5 | | | | EXAMPLE 6 | | | |
|---|---|---|---|---|---|---|---|---|---|
| | | INK SET 5 | | | | INK SET 6 | | | |
| COMPOSITION | | 1Y | 1M | 1C | 1K | 2Y | 2M | 2C | 2K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 28 | 28 | 28 | 5.6 | 28 | 28 | 28 | 5.6 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | — | — | — | — | — | — | — | — |
| | RESIN | | | | | | | | |
| ALCOHOLIC | 1,2- | 1 | 1 | 1 | 1 | 3 | 3 | 3 | 3 |
| SOLVENT | OCTANEDIOL | | | | | | | | |
| | 1,2- | 0.5 | 0.5 | 0.5 | 0.5 | 0.5 | 0.5 | 0.5 | 0.5 |
| | HEXANEDIOL | | | | | | | | |
| | 3-METHYL-1,3- | 3 | 3 | 3 | 3 | 3 | 3 | 3 | 3 |
| | BUTANEDIOL | | | | | | | | |
| | 1,2,6- | 6 | 6 | 6 | 6 | 6 | 6 | 6 | 6 |
| | HEXANETRIOL | | | | | | | | |
| SURFACTANT | | 0.1 | 0.1 | 0.1 | 0.1 | 0.1 | 0.1 | 0.1 | 0.1 |
| PURE WATER | | BALANCE | BALANCE | BALANCE | BALANCE | BALANCE | BALANCE | BALANCE | BALANCE |
| TOTAL | | 100 | 100 | 100 | 100 | 100 | 100 | 100 | 100 |
| | | EXAMPLE 7 | | | | EXAMPLE 8 | | | |
| | | INK SET 7 | | | | INK SET 8 | | | |
| COMPOSITION | | 3Y | 3M | 3C | 3K | 4Y | 4M | 4C | 4K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 28 | 28 | 28 | 5.6 | 28 | 28 | 28 | 5.6 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | — | — | — | — | — | — | — | — |
| | RESIN | | | | | | | | |
| ALCOHOLIC | 1,2- | 1 | 1 | 1 | 1 | 3 | 3 | 3 | 3 |
| SOLVENT | OCTANEDIOL | | | | | | | | |
| | 1,2- | 3 | 3 | 3 | 3 | 3 | 3 | 3 | 3 |
| | HEXANEDIOL | | | | | | | | |
| | 3-METHYL-1,3- | 6 | 6 | 6 | 6 | 3 | 3 | 3 | 3 |
| | BUTANEDIOL | | | | | | | | |
| | 1,2,6- | 12 | 12 | 12 | 12 | 6 | 6 | 6 | 6 |
| | HEXANETRIOL | | | | | | | | |

| | | | | | | | | |
|---|---|---|---|---|---|---|---|---|
| SURFACTANT | 0.1 | 0.1 | 0.1 | 0.1 | 0.1 | 0.1 | 0.1 | 0.1 |
| PURE WATER | BALANCE | BALANCE | BALANCE | BALANCE | BALANCE | BALANCE | BALANCE | BALANCE |
| TOTAL | 100 | 100 | 100 | 100 | 100 | 100 | 100 | 100 |

TABLE 3

| | | EXAMPLE 9 | | | | EXAMPLE 10 | | | |
|---|---|---|---|---|---|---|---|---|---|
| | | INK SET 9 | | | | INK SET 10 | | | |
| COMPOSITION | | 1Y | 1M | 1C | 1K | 2Y | 2M | 2C | 2K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 1.4 | 1.4 | 1.4 | 28 | 1.4 | 1.4 | 1.4 | 28 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | 1.4 | 1.4 | 1.4 | 28 | 1.4 | 1.4 | 1.4 | 28 |
| | RESIN | | | | | | | | |
| ALCOHOLIC | 1,2- | 1 | 1 | 1 | 1 | 3 | 3 | 3 | 3 |
| SOLVENT | OCTANEDIOL | | | | | | | | |
| | 1,2- | 0.5 | 0.5 | 0.5 | 0.5 | 0.5 | 0.5 | 0.5 | 0.5 |
| | HEXANEDIOL | | | | | | | | |
| | 3-METHYL-1,3- | 3 | 3 | 3 | 3 | 3 | 3 | 3 | 3 |
| | BUTANEDIOL | | | | | | | | |
| | 1,2,6- | 1.5 | 1.5 | 1.5 | 1.5 | 1.5 | 1.5 | 1.5 | 1.5 |
| | HEXANETRIOL | | | | | | | | |
| SURFACTANT | | 0.1 | 0.1 | 0.1 | 0.1 | 0.1 | 0.1 | 0.1 | 0.1 |
| PURE WATER | | BALANCE | BALANCE | BALANCE | BALANCE | BALANCE | BALANCE | BALANCE | BALANCE |
| | | EXAMPLE 11 | | | | EXAMPLE 12 | | | |
| | | INK SET 11 | | | | INK SET 12 | | | |
| COMPOSITION | | 3Y | 3M | 3C | 3K | 4Y | 4M | 4C | 4K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 1.4 | 1.4 | 1.4 | 28 | 1.4 | 1.4 | 1.4 | 28 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | 1.4 | 1.4 | 1.4 | 28 | 1.4 | 1.4 | 1.4 | 28 |
| | RESIN | | | | | | | | |
| ALCOHOLIC | 1,2- | 1 | 1 | 1 | 1 | 3 | 3 | 3 | 3 |
| SOLVENT | OCTANEDIOL | | | | | | | | |
| | 1,2- | 3 | 3 | 3 | 3 | 3 | 3 | 3 | 3 |
| | HEXANEDIOL | | | | | | | | |
| | 3-METHYL-1,3- | 6 | 6 | 6 | 6 | 3 | 3 | 3 | 3 |
| | BUTANEDIOL | | | | | | | | |
| | 1,2,6- | 3 | 3 | 3 | 3 | 1.5 | 1.5 | 1.5 | 1.5 |
| | HEXANETRIOL | | | | | | | | |

| | | | | | | | | |
|---|---|---|---|---|---|---|---|---|
| SURFACTANT | 0.1 | 0.1 | 0.1 | 0.1 | 0.1 | 0.1 | 0.1 | 0.1 |
| PURE WATER | BALANCE | BALANCE | BALANCE | BALANCE | BALANCE | BALANCE | BALANCE | BALANCE |

TABLE 4

| | | EXAMPLE 13 | | | | EXAMPLE 14 | | | |
|---|---|---|---|---|---|---|---|---|---|
| | | INK SET 13 | | | | INK SET 14 | | | |
| COMPOSITION | | 1Y | 1M | 1C | 1K | 2Y | 2M | 2C | 2K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 1.4 | 1.4 | 1.4 | 28 | 1.4 | 1.4 | 1.4 | 28 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | 1.4 | 1.4 | 1.4 | 28 | 1.4 | 1.4 | 1.4 | 28 |
| | RESIN | | | | | | | | |
| ALCOHOLIC | 1,2- | 1 | 1 | 1 | 1 | 3 | 3 | 3 | 3 |
| SOLVENT | OCTANEDIOL | | | | | | | | |
| | 1,2- | 0.5 | 0.5 | 0.5 | 0.5 | 0.5 | 0.5 | 0.5 | 0.5 |
| | HEXANEDIOL | | | | | | | | |
| | 3-METHYL-1,3- | 3 | 3 | 3 | 3 | 3 | 3 | 3 | 3 |
| | BUTANEDIOL | | | | | | | | |
| | 1,2,6- | 6 | 6 | 6 | 6 | 6 | 6 | 6 | 6 |
| | HEXANETRIOL | | | | | | | | |
| SURFACTANT | | 0.1 | 0.1 | 0.1 | 0.1 | 0.1 | 0.1 | 0.1 | 0.1 |
| PURE WATER | | BALANCE | BALANCE | BALANCE | BALANCE | BALANCE | BALANCE | BALANCE | BALANCE |
| TOTAL | | 100 | 100 | 100 | 100 | 100 | 100 | 100 | 100 |
| | | EXAMPLE 15 | | | | EXAMPLE 16 | | | |
| | | INK SET 15 | | | | INK SET 16 | | | |
| COMPOSITION | | 3Y | 3M | 3C | 3K | 4Y | 4M | 4C | 4K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 1.4 | 1.4 | 1.4 | 28 | 1.4 | 1.4 | 1.4 | 28 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | 1.4 | 1.4 | 1.4 | 28 | 1.4 | 1.4 | 1.4 | 28 |
| | RESIN | | | | | | | | |
| ALCOHOLIC | 1,2- | 1 | 1 | 1 | 1 | 3 | 3 | 3 | 3 |
| SOLVENT | OCTANEDIOL | | | | | | | | |
| | 1,2- | 3 | 3 | 3 | 3 | 3 | 3 | 3 | 3 |
| | HEXANEDIOL | | | | | | | | |
| | 3-METHYL-1,3- | 6 | 6 | 6 | 6 | 3 | 3 | 3 | 3 |
| | BUTANEDIOL | | | | | | | | |
| | 1,2,6- | 12 | 12 | 12 | 12 | 6 | 6 | 6 | 6 |
| | HEXANETRIOL | | | | | | | | |

| | | | | | | | | |
|---|---|---|---|---|---|---|---|---|
| SURFACTANT | 0.1 | 0.1 | 0.1 | 0.1 | 0.1 | 0.1 | 0.1 | 0.1 |
| PURE WATER | BALANCE | BALANCE | BALANCE | BALANCE | BALANCE | BALANCE | BALANCE | BALANCE |
| TOTAL | 100 | 100 | 100 | 100 | 100 | 100 | 100 | 100 |

TABLE 5

| | | COMPARATIVE EXAMPLE 1 | | | | COMPARATIVE EXAMPLE 2 | | | |
|---|---|---|---|---|---|---|---|---|---|
| | | INK SET 17 | | | | INK SET 18 | | | |
| COMPOSITION | | 1Y | 1M | 1C | 1K | 2Y | 2M | 2C | 2K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 28 | 28 | 28 | 5.6 | 28 | 28 | 28 | 5.6 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | — | — | — | — | — | — | — | — |
| | RESIN | | | | | | | | |
| ALCOHOLIC | 1,2- | 0 | 0 | 0 | 0 | 3 | 3 | 3 | 3 |
| SOLVENT | OCTANEDIOL | | | | | | | | |
| | 1,2- | 3 | 3 | 3 | 3 | 0 | 0 | 0 | 0 |
| | HEXANEDIOL | | | | | | | | |
| | 3-METHYL-1,3- | 6 | 6 | 6 | 6 | 6 | 6 | 6 | 6 |
| | BUTANEDIOL | | | | | | | | |
| | 1,2,6- | 12 | 12 | 12 | 12 | 12 | 12 | 12 | 12 |
| | HEXANETRIOL | | | | | | | | |
| SURFACTANT | | 0.1 | 0.1 | 0.1 | 0.1 | 0.1 | 0.1 | 0.1 | 0.1 |
| PURE WATER | | BALANCE | BALANCE | BALANCE | BALANCE | BALANCE | BALANCE | BALANCE | BALANCE |
| TOTAL | | 100 | 100 | 100 | 100 | 100 | 100 | 100 | 100 |
| | | COMPARATIVE EXAMPLE 3 | | | | COMPARATIVE EXAMPLE 4 | | | |
| | | INK SET 19 | | | | INK SET 20 | | | |
| COMPOSITION | | 3Y | 3M | 3C | 3K | 4Y | 4M | 4C | 4K |
| COLORANT | C.I. Pigment | 7.0 | — | — | — | 7.0 | — | — | — |
| | Yellow 74 | | | | | | | | |
| | C.I. Pigment | — | 7.0 | — | — | — | 7.0 | — | — |
| | Red 202 | | | | | | | | |
| | C.I. Pigment | — | — | 7.0 | — | — | — | 7.0 | — |
| | Blue 15:3 | | | | | | | | |
| | C.I. Pigment | — | — | — | 7.0 | — | — | — | 7.0 |
| | Black 7 | | | | | | | | |
| DISPERSANT | STYRENE- | 28 | 28 | 28 | 5.6 | 28 | 28 | 28 | 5.6 |
| | ACRYLIC ACID | | | | | | | | |
| | RESIN | | | | | | | | |
| | URETHANE | — | — | — | — | — | — | — | — |
| | RESIN | | | | | | | | |
| | FLUORENE | — | — | — | — | — | — | — | — |
| | RESIN | | | | | | | | |
| ALCOHOLIC | 1,2- | 3 | 3 | 3 | 3 | 3 | 3 | 3 | 3 |
| SOLVENT | OCTANEDIOL | | | | | | | | |
| | 1,2- | 3 | 3 | 3 | 3 | 3 | 3 | 3 | 3 |
| | HEXANEDIOL | | | | | | | | |
| | 3-METHYL-1,3- | 0 | 0 | 0 | 0 | 6 | 6 | 6 | 6 |
| | BUTANEDIOL | | | | | | | | |
| | 1,2,6- | 12 | 12 | 12 | 12 | 0 | 0 | 0 | 0 |
| | HEXANETRIOL | | | | | | | | |

| | | | | | | | | |
|---|---|---|---|---|---|---|---|---|
| SURFACTANT | 0.1 | 0.1 | 0.1 | 0.1 | 0.1 | 0.1 | 0.1 | 0.1 |
| PURE WATER | BALANCE | BALANCE | BALANCE | BALANCE | BALANCE | BALANCE | BALANCE | BALANCE |
| TOTAL | 100 | 100 | 100 | 100 | 100 | 100 | 100 | 100 |

### Examples 17 to 32 and Comparative Examples 5 to 8

In addition, ink sets 17 to 32 of the examples and ink sets 5 to 8 of the comparative examples were prepared in a manner similar to that described above except that the surfactants of the ink sets of Examples 1 to 16 and Comparative Examples 1 to 4 were replaced with the following surfactants.

The surfactants used in Examples 17 to 32 and Comparative Examples 5 to 8 were surfactants each formed of a compound represented by the above formula (I) in which R indicated a methyl group, a indicated an integer of 6 to 10, m indicated an integer of 10 to 20, and n indicated an integer of 4 to 8.

### Examples 33 to 48 and Comparative Examples 9 to 12

In addition, ink sets 33 to 48 of the examples and ink sets 9 to 12 of the comparative examples were prepared in a manner similar to that described above except that the surfactants of the ink sets of Examples 1 to 16 and Comparative Examples 1 to 4 were replaced with the following surfactants.

The surfactants used in Examples 33 to 48 and Comparative Examples 9 to 12 were surfactants each formed of a mixture containing, in accordance with the above formula (I), a compound in which R indicated a hydrogen atom, a indicated an integer of 7 to 11, m indicated an integer of 30 to 50, and n indicated an integer of 3 to 5, a compound in which R indicated a methyl group, a indicated an integer of 9 to 13, m indicated an integer of 2 to 4, and n indicated an integer of 1 or 2, and a compound in which R indicated a methyl group, a indicated an integer of 6 to 10, m indicated an integer of 10 to 20, and n indicated an integer of 4 to 8.

### Examples 49 to 64 and Comparative Examples 13 to 16

In addition, ink sets 49 to 64 of the examples and ink sets 13 to 16 of the comparative examples were prepared in a manner similar to that described above except that the surfactants of Examples 1 to 16 and Comparative Examples 1 to 4 were replaced with the following surfactants.

The surfactants used in Examples 49 to 64 and Comparative Examples 13 to 16 were surfactants each formed of a compound represented by the above formula (I) in which R indicated a methyl group, a indicated an integer of 6 to 18, m indicated 0, and n indicated 1.

### Evaluations

### Evaluation of Ink Initial Viscosity

The ink viscosity of each ink obtained as described above was evaluated. The viscosity of each ink was measured using a vibration viscometer (model MV100 manufactured by Yamaichi Electronics Co, Ltd.) after the elapse of 1 hour from the preparation of the ink and was evaluated in accordance with the following criteria. The measurement temperature was set to 20° C.

S: The viscosity is 4 mPa·s or less.
AA: The viscosity is in the range of more than 4 mPa·s to 5 mPa·s.
A: The viscosity is in the range of more than 5 mPa·s to 6 mPa·s.
B: The viscosity is in the range of more than 6 mPa·s to 7 mPa·s.
C: The viscosity is in the range of more than 7 mPa·s to 8 mPa·s.
D: The viscosity is more than 8 mPa·s.

The evaluation results are shown in the following Table 6.

Evaluation of Ink Viscosity with Time

After the inks thus prepared were held for 3 days under conditions at 70° C., the viscosity of each ink was then measured in a manner similar to that described above and was evaluated in accordance with the following criteria.

A: The difference from the initial viscosity is 0.5 mPa·s or less.
B: The difference from the initial viscosity is in the range of more than 0.5 mPa·s to 1.0 mPa·s.
C: The difference from the initial viscosity is in the range of more than 1.0 mPa·s to 2.0 mPa·s.
D: The difference from the initial viscosity is more than 2.0 mPa·s.

The evaluation results are shown in the following Table 6.

### Evaluation of Agglomeration Irregularities and Filling Properties

The inks of Y, M, C, K obtained as described above were combined into one ink set and were installed in an ink cartridge of an ink jet printer (PX-G920 manufactured by SEIKO EPSON CORPORATION) so that recording could be carried out at 720 dpi in a main scanning (head driving) direction and at 360 dpi in a subscanning (recording medium transport) direction. Next, the voltage of the printer was adjusted such that the size of a dot landing on a recording medium was about 7 ng. A solid image at 720×720 dpi was recorded at 720×360 dpi per one drive on OKT+ (manufactured by Oji Paper Co., Ltd.) having a weight of approximately 128 g/m². The recording was carried out under conditions at normal temperature and at normal humidity. The adhesion amount of ink was approximately 3.6 mg/inch².

The images thus obtained were evaluated in accordance with the following criteria.

A: No agglomeration irregularities and no white streaks caused by filling failure are observed.
B: No agglomeration irregularities are observed, but white streaks caused by filling failure are observed.
C: Agglomeration irregularities and white streaks caused by filling failure are observed.
D: The flow of ink is so aggressive that evaluation cannot be performed.

The evaluation results are shown in the following Table 6.

### Evaluation of Curling

Printing was carried out in a manner similar to that described above except that as a recording medium, OKT+ (manufactured by Oji Paper Co., Ltd.) having a weight of approximately 104.7 g/m² was used. The recording medium thus printed was placed on a flat desk so that an ink-receiving surface faced upward for 24 hours under conditions at 25° C. and at a relative humidity of 40% for spontaneous drying. Subsequently, the distances between the desk and four curled corners of the recording medium were measured and were then averaged.

AA: The distance is less than 5 mm.
A: The distance is in the range of 5 mm to less than 10 mm.
B: The distance is in the range of 10 mm to less than 20 mm.
C: The distance is 20 mm or more.

The evaluation results are shown in the following Table 6.

### Evaluation of Initial Fixability

The recording medium of OKT+ thus printed was rubbed by a finger after 3 minutes from the printing.

A: No color material is peeled away.
B: Color material is peeled away.

The evaluation results are shown in the following Table 6.

### Evaluation of Solubility of Slightly Water-Soluble Alkanediol

As the slightly water-soluble alkanediol, 1,2-octanediol was used, and an aqueous 1,2-octanediol solution at a concentration of 10 percent by weight was formed. In this aqueous solution, 1,2-octanediol was not completely dissolved, and a white cloudy state was formed.

Five types of alcoholic solvents, 1,2-hexanediol (hereinafter referred to as “HED”), 3-methyl-1,3-butanediol (hereinafter referred to as “3MBUD”), 1,3-butanediol (hereinafter referred to as “1,3-BUD”), 1,2,6-hexanetriol (hereinafter referred to as “HET”), and 3-methyl-1,3,5-pentanetriol (hereinafter referred to as “3MPET”) were each added to 10 g of the aqueous solution prepared as described above until the solution became clear.

In addition, instead of the above aqueous solution, an aqueous solution was prepared which contained 10 percent by weight of 1,2-octanediol as the slightly water-soluble alkanediol and 10 percent by weight of 1,2 hexanediol as the water-soluble 1,2-alkanediol, and in a manner similar to that described above, the individual alcoholic solvents were each added until the solution became clear.

The addition amount (g) of each alcoholic solvent at which the aqueous solution became clear, that is, at which the slightly water-soluble alkanediol was completely dissolved, is shown in FIG. 19.

As apparent from FIG. 19, it is found that in the two-component alcoholic solvent containing 1,2-octanediol and 1,2-hexanediol, 3MBUD, which is an alkanediol in which one carbon having a hydroxyl group has a side chain, has a superior capability of dissolving 1,2-octanediol to that of 1,3-BUD which is an alkanediol in which one carbon having a hydroxyl group has no side chain. In addition, it is also found that 3MBUD has a superior capability of dissolving 1,2-octanediol to that obtained in the case in which only HED is added.

On the other hand, as apparent from FIG. 19, it is found that in an aqueous solution containing 1,2-octanediol, HET and 3MPET, which are water-soluble alkanetriols, each have inferior capability of dissolving 1,2-octanediol to that obtained in the case in which only HED is added. Hence, in an ink composition containing 1,2-octancediol, it is found that 3MBUD, which is an alkanediol in which one carbon having a hydroxyl group has a side chain, and 1,2-hexanediol, which is a water-soluble 1,2-alkanediol, are preferably contained at the same time.

### Evaluation of Clogging Recovery Properties

The ink cartridge and the ink jet printer described above were used, and a button for exchanging inks was pressed, and a cord was removed from an outlet. In the state in which a head cap was detached as described above, the printer was held for 1 day under conditions at 40° C. and at a relative humidity of 15%. After the printer was held for 1 day, cleaning operation was repeatedly performed until all the nozzles performed ejection as same as that at the initial usage. Subsequently, recoverability was evaluated in accordance with the following criteria.

A: Recovery from clogging is obtained by 3 cleaning operations.
B: Recovery from clogging is obtained by 6 cleaning operations.
C: Recovery from clogging is obtained by 12 cleaning operations.
D: Recovery from clogging is not obtained by 12 cleaning operations.

The evaluation results are shown in the following Table 6.

TABLE 6

| | INK | EVALUATION OF | INK AGGLOMERATION | | EVALUATION | CLOGGING |
|---|---|---|---|---|---|---|
| | INITIAL | INK VISCOSITY | IRREGULARITIES AND | EVALUATION | OF INITIAL | RECOVERY |
| | VISCOSITY | WITH TIME | FILLING PROPERTIES | OF CURLING | FIXABILITY | PROPERTIES |
| EXAMPLE 1 | A | C | C | C | A | C |
| EXAMPLE 2 | C | D | B | C | A | C |
| EXAMPLE 3 | C | D | C | C | A | B |
| EXAMPLE 4 | C | D | B | C | A | C |
| EXAMPLE 5 | B | C | C | B | A | B |
| EXAMPLE 6 | C | D | B | B | A | B |
| EXAMPLE 7 | C | D | C | A | B | A |
| EXAMPLE 8 | C | D | A | C | A | B |
| EXAMPLE 9 | S | A | B | C | A | B |
| EXAMPLE 10 | AA | A | A | C | A | B |
| EXAMPLE 11 | AA | A | B | C | A | B |
| EXAMPLE 12 | AA | A | A | C | A | B |
| EXAMPLE 13 | S | A | B | B | A | B |
| EXAMPLE 14 | AA | A | A | B | A | B |
| EXAMPLE 15 | AA | A | C | A | B | A |
| EXAMPLE 16 | AA | A | A | C | A | B |
| COMPARATIVE | C | B | D | A | B | B |
| EXAMPLE 1 | | | | | | |
| COMPARATIVE | C | D | B | A | C | B |
| EXAMPLE 2 | | | | | | |
| COMPARATIVE | C | D | A | C | A | B |
| EXAMPLE 3 | | | | | | |
| COMPARATIVE | C | D | A | C | A | B |
| EXAMPLE 4 | | | | | | |

In addition, evaluations similar to those described above were performed for Examples 17 to 32 and Comparative Examples 5 to 8, and the results were the same as those of Examples 1 to 16 and Comparative Examples 1 to 4.

Furthermore, evaluations similar to those described above were performed for Examples 33 to 48 and Comparative Examples 9 to 12, and the results were the same as those of Examples 1 to 16 and Comparative Examples 1 to 4.

In addition, evaluations similar to those described above were performed for Examples 49 to 64 and Comparative Examples 13 to 16, and the results were the same as those of Examples 1 to 16 and Comparative Examples 1 to 4.

In addition, Examples 65 to 128 were formed in the same manner as that described above except that 3-methyl-1,3,5-pentanetriol was used instead of 1,2,6-hexanetriol used in Examples 1 to 64 and Comparative Examples 1 to 16. When evaluation similar to that described above was performed, the same evaluation results as those of Examples 1 to 64 and Comparative Examples 1 to 16 were obtained except the evaluation results of curling. The evaluation result of curling was improved by one rank. Accordingly, it is found that an alkanetriol in which one carbon having a hydroxyl group has a side chain has a superior effect of suppressing curling.

### Other Embodiments

In the above embodiment, as the liquid ejection apparatus, the printer 1 is described; however, the liquid ejection apparatus is not limited thereto and may also be applied to a liquid ejection apparatus which sprays or ejects a fluid other than ink (such as liquid, a liquid substance containing grains of a functional material dispersed therein, or a fluid substance such as gel). For example, techniques similar to those of the above embodiment may also be applied to a color filter manufacturing apparatus, a dying apparatus, a fine machining apparatus, a semiconductor device manufacturing apparatus, a surface machining apparatus, a three-dimensional shaping apparatus, a liquid evaporation apparatus, an organic EL manufacturing apparatus (in particular, a high molecular weight EL manufacturing apparatus), a display manufacturing apparatus, a film forming apparatus, and various apparatuses, such as a DNA chip manufacturing apparatus, using an ink jet technique. In addition, the apparatuses and manufacturing methods thereof are also in the application range of the embodiments.

The above embodiments have been described in order to facilitate understanding of the invention, and the invention is not limited thereto. It is naturally to be understood that the invention may be changed and modified without departing from the spirit and the scope of the invention and that equivalents are also included in the invention.

What is claimed is:

1. A printer comprising:
a head ejecting an ink including a colorant, water, an alcoholic solvent, and a surfactant to form an image, the alcoholic solvent containing at least one slightly water-soluble alkanediol; and
a control portion controlling the head so as not to eject the ink to edge pixels of the image when the image is formed on a medium.

2. The printer according to claim 1, wherein the alcoholic solvent contains the slightly water-soluble alkanediol, a water-soluble 1,2-alkanediol, an alkanediol in which one carbon having a hydroxyl group has a side chain, and a water-soluble alkanetriol.

3. The printer according to claim 2, wherein the slightly water-soluble alkanediol is an alkanediol having at least 7 carbon atoms.

4. The printer according to claim 2, wherein the water-soluble 1,2-alkanediol is an alkanediol having 6 carbon atoms or less.

5. The printer according to claim 1, wherein the colorant contains a pigment and a dispersant capable of dispersing the pigment in the ink.

6. The printer according to claim 1, wherein when the image is formed on the medium, the control portion finds a post-filter application image which is obtained by applying an edge filter to the image, finds edge pixels by performing a binary processing on the post-filter application image, and uses a data in which pixels of the image corresponding to the edge pixels are set to colorless pixels, so that the head is controlled not to eject the ink to the edge pixels.

7. The printer according to claim 1, wherein the medium is synthetic paper primarily containing a synthetic resin or coated printing paper.

8. A printing method comprising:
finding edge pixels of an image; and
ejecting an ink including a colorant, water, an alcoholic solvent, and a surfactant to pixels other than the edge pixels to form the image on a medium, the alcoholic solvent containing at least one slightly water-soluble alkanediol.
